(19) United States
(12) Patent Application Publication
(10) Pub. No.: US 2004/0122700 A1
(43) Pub. Date: Jun. 24, 2004

(54) Charge management method, charge device, network monitor device, web portal server, charge management program, content distribution server and charge management system

(76) Inventors: Hideyuki Aoki, Kawasaki (JP); Eiichiro Takahashi, Kawasaki (JP); Hisayuki Sekine, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/733,189

(22) Filed: Dec. 11, 2003

(30) Foreign Application Priority Data
Dec. 12, 2002 (JP) 2002-361207

(51) Int. Cl. G06F 17/60

(52) U.S. Cl. 705/1; 705/30

(57) ABSTRACT

A network monitor center monitors states of a switch such as an M/C, EPON or the like, a router/sw, etc. that configure a network, and transmits a result of monitoring to a Web portal server; the Web portal server indicates, based on the result of the monitoring by the network monitor center, a content distribution server to change a resolution rate; and a charge center imposes a charge based on a result of having changed the resolution rate.

### BACKGROUND OF THE INVENTION

1. Field of the Invention

The invention relates to a charge management method, charge device, a network monitor device, a Web portal server, a charge management program, a content distribution server, and a charge management system that are utilized in the case of performing a content distribution, and more particularly to a charge management method, charge device, a network monitor device, a Web portal server, a charge management program, a content distribution server, and a charge management system that are well suited to being applied to commercial content distribution network services in which charged services for distributing rich contents are developed, and a listening/watching right to a designated content is given to a contract subscriber.

2. Description of the Related Art

The content distribution services utilizing the networks have hitherto been utilized. In these services, mainly images, etc. are distributed as a content.

Then, such a content distribution service is generally charged money, a charge corresponding to the content distributed is imposed, and the charge was collected from every user.

Therefore, in the case of distributing, e.g., image data, it is an important problem how a quality of that image is maintained.

On the other hand, there is a dynamic resolution conversion (DRC: Dynamic Resolution Conversion) as a technique for stabilizing a frame rate.

The dynamic resolution conversion (DRC: Dynamic Resolution Conversion) is the technique adopted for a multimedia encoding standard ┌MPEG-4 Version2┘ to the International Organization for Standardization/International Electrotechnical Commission (ISO/IEC), and is the technique for stabilizing the frame rate by changing in real time minuteness on a screen when transmitting in compression, corresponding to intensiveness of motions of pictures.

Note that the DRC is defined in ISO/IEC 14496-2:2001.

For a supplement to the DRC, the DRC is a part of MPEG-4 Version2 ARTS Profile (ARTS=Advanced Real-Time Simple (ARTS) Profile (version 2)).

Further, if on the WEB, there is the following page, a description of the ARTS is given therein.

http://library.n0i.net/graphics/mp-eg4_overview/

[Patent Document 1]

Japanese Patent Application Laid-Open Publication No. 7-288673

In the conventional content distribution service, however, such a picture disturbance as to hinder listening/watching (a picture unreproducible state due to an abrupt packet loss) might occur depending on a change in a using band of the network, a fault situation of a port managed for every appliance, etc., and it was difficult to ensure a continuity of the content distribution service.

Therefore, in the charged content distribution service, there was a case in which many complaints arose among the users.

### SUMMARY OF THE INVENTION

The invention was devised in view of the circumstances, and its purpose lies in providing a charge management method, charge device, a network monitor device, a Web portal server, a charge management program, a content distribution server, and a charge management system that are capable of continuing a service without causing, though deterioration in a resolution rate is recognized in a picture that is in the process of being listened to and watched, such a disturbance (a picture unreproducible state due to an abrupt packet loss) as to hinder the listening/watching, and performing, in case a resolution rate of the distribution content deteriorates, a content charge discount service.

To accomplish the object, a charge management method according to the invention is applied to a charge management system connected to a network connected to at least one or more user terminals, and including monitoring unit, distributing unit and accounting unit,and comprises, monitoring appliances configuring the network, distributing a content to the user terminal; and calculating a accounting information for the user terminal on the basis of a content distribution situation; and wherein the distributing includes dynamically changing a resolution rate of the content on the basis of a monitored result in the monitoring, and the calculating includes calculating the accounting information on the basis of the changed resolution rate of the content.

Further, a charge management method according to the invention, wherein the charge management system includes permitting unit connected to the network, further comprises, determining whether a distribution of the content to the user terminal is permitted or not, wherein the monitoring includes monitoring a content distribution condition affecting the content distribution, such as a change in a using band of the network, a fault situation of a port managed for every appliance, etc., and transmitting, in case the content distribution condition changes, change information thereof to the permitting unit, and indicating the distributing unit to change the resolution rate on the basis of the change information.

Further, in a charge management method according to the invention, wherein the indicating includes selecting the content distributed on a route shown by the change information and indicating the distributing unit to adjust a resolution rate of the selected content.

Further, a charge management method according to the invention, wherein the distributing includes changing the resolution rate through a dynamic resolution conversion (DRC: Dynamic Resolution Conversion) based on an adjustment request received from the permitting unit for ensuring a continuity of a service by adjusting a traffic quantity of the content distribution, preventing a disturbance of picture and keeping a condition worth listening to and watching, and further comprises first transmitting to the permitting unit, resolution rate information of the content with its resolution rate changed and distribution destination user identifying information.

Further, a charge management method according to the invention, further comprises second transmitting, when the distribution of the content is ended, the resolution rate change information and the distribution destination user identifying information to the permitting unit.

Further, a charge management method according to the invention, further comprises third transmitting, when receiving the resolution rate change information through the dynamic resolution conversion which has been transmitted from the distributing unit, the resolution rate information to the monitoring unit.

Further, a charge management method according to the invention, further comprises fourth transmitting, triggered by the end of the content distribution, to the monitoring unit the resolution rate information and the distribution destination user identifying information that have been received from the distributing unit.

Further, in a charge management method according to the invention, wherein the distributing includes receiving an adjustment request from the permitting unit and changing the encoding system through the dynamic encoding conversion from the information thereof, for ensuring the continuity of the service by adjusting a traffic quantity of the content distribution, preventing the disturbance of picture, and keeping the condition worth listening to and watching.

Further, in a charge management method according to the invention, wherein the calculating includes accumulating a degree of discount based on a decrease quantity of the resolution rate and a distribution time in a decreased state, converting the degree of discount into a discount rate on a charge collection unit such as per end of month, etc., and calculating the accounting information by multiplying a standard charge by the discount rate.

Further, a charge device is connected to a charge management system which comprises at least one or more user terminals, monitoring unit monitoring appliances configuring a network, and distributing unit distributing a content to the user terminal, and wherein the distributing unit dynamically changes a resolution rate of the content on the basis of a result of the monitoring by the monitoring unit, comprises, accumulating unit accumulating a degree of discount based on a decrease quantity of the resolution rate and a distribution time in a decreased state, converting unit converting the degree of discount into a discount rate on a charge collection unit such as per end of month, etc., and calculating unit calculating an accounting information by multiplying a standard charge by the discount rate.

Further, a network monitor device connected to a charge management system which comprises at least one or more user terminals, distributing unit distributing a content to the user terminal, accounting unit calculating accounting information for the user terminal on the basis of a content distributing situation, and permitting unit for determining whether the distribution of the content to the user terminal is permitted or not, wherein the distributing unit dynamically changes a resolution rate of the content, and the accounting unit calculates the accounting information on the basis of the changed resolution rate of the content, comprises, monitoring unit monitoring a content distribution condition affecting the content distribution, such as a change in a using band of the network, a fault situation of a port managed for every appliance, etc.; and transmitting unit transmitting, in case the content distribution condition changes, change information thereof to the permitting unit, wherein the permitting unit indicates the distributing unit to change the resolution rate on the basis of the received change information.

Further, a network monitor device according to claim 11, further comprises, first receiving unit receiving the resolution rate information, which is transmitted by the permitting unit when the permitting unit receives the resolution rate change information through the dynamic resolution conversion from the distributing unit.

Further, a network monitor device according to claim 11, further comprises second receiving unit receiving the resolution rate information and the distribution destination user identifying information, that the permitting unit have been received from the distributing unit, from the permitting unit, triggered by the end of the content distribution.

Further, a Web portal server connected to a charge management system which comprises at least one or more user terminals, monitoring unit monitoring appliances configuring a network, distributing unit distributing a content to the user terminal, and accounting unit calculating accounting information for the user terminal on the basis of a content distributing situation, wherein the distributing unit dynamically changes a resolution rate of the content on the basis of a result of the monitoring by the monitoring unit, the accounting unit calculates the accounting information on the basis of the changed resolution rate of the content, and the monitoring unit monitors a content distribution condition affecting the content distribution, such as a change in a using band of the network, a fault situation of a port managed for every appliance, etc., and transmits, in case the content distribution condition changes, the change information thereof, and determining whether the distribution of the content to the user terminal is permitted or not, comprises, selecting unit selecting the content distributed on a route shown by the change information, and indicating unit indicating the distributing unit to adjust a resolution rate of the selected content.

Further, in a Web portal server according to the invention, wherein the indication of the indicating unit makes the distributing unit changed the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and the distributing unit transmits, to the Web portal server, resolution rate information of the content with its resolution rate changed and distribution destination user identifying information.

Further, a Web portal server according to the invention, further comprises receiving unit receiving a resolution rate change information and a distribution destination user identifying information, which is transmitted from the distributing unit when the distribution of the content is ended.

Further, a Web portal server according to the invention, further comprises first transmitting unit transmitting, when receiving a resolution rate change information through the dynamic resolution conversion which has been transmitted from the distributing unit, the resolution rate information to the monitoring unit.

Further, a Web portal server according to the invention, further comprises second transmitting unit transmitting, triggered by the end of the content distribution, the resolution rate information and the distribution destination user identifying information, that have been received from the distributing unit, to the monitoring unit.

Further, in a Web portal server according to the invention, wherein the indication of the indicating unit makes the distributing unit changed the encoding system through the dynamic encoding conversion from the received information of the indication, for ensuring the continuity of the service by adjusting a traffic quantity of the content distribution, preventing the disturbance of picture and keeping the condition worth listening to and watching.

Further, a charge management program applied to a Web portal server connected to a charge management system which comprises at least one or more user terminals, monitoring unit monitoring appliances configuring a network, distributing unit distributing a content to the user terminal, and accounting unit calculating accounting information for the user terminal on the basis of a content distributing situation, wherein the distributing unit dynamically changes a resolution rate of the content on the basis of a result of the monitoring by the monitoring unit, the accounting unit calculates the accounting information on the basis of the changed resolution rate of the content, and the monitoring unit monitors a content distribution condition affecting the content distribution, such as a change in a using band of the network, a fault situation of a port managed for every appliance, etc., and transmits, in case the content distribution condition changes, the change information thereof, and determining whether the distribution of the content to the user terminal is permitted or not, comprises, making the Web portal server functioned as selecting unit selecting the content distributed on a route shown by the change information, and making the Web portal server functioned as indicating unit indicating the distributing unit to adjust a resolution rate of the selected content.

Further, in a charge management program according to the invention, wherein the indication of the indicating unit makes the distributing unit changed the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and the distributing unit transmits, to the Web portal server, resolution rate information of the content with its resolution rate changed and distribution destination user identifying information.

Further, a charge management program according to the invention, further comprises making the Web portal server functioned as receiving unit receiving a resolution rate change information and a distribution destination user identifying information, which is transmitted from the distributing unit when the distribution of the content is ended.

Further, a charge management program according to the invention, further comprises making the Web portal server functioned as first transmitting unit transmitting, when receiving a resolution rate change information through the dynamic resolution conversion which has been transmitted from the distributing unit, the resolution rate information to the monitoring unit.

Further, a charge management program according to the invention, further comprises making the Web portal server functioned as second transmitting unit transmitting, triggered by the end of the content distribution, the resolution rate information and the distribution destination user identifying information that have been received from the distributing unit to the monitoring unit.

Further, in a charge management program according to the invention, wherein the indication of the indicating unit makes the distributing unit changed the encoding system through the dynamic encoding conversion from the received information of the indication, for ensuring the continuity of the service by adjusting a traffic quantity of the content distribution, preventing the disturbance of picture and keeping the condition worth listening to and watching.

Further, a content distribution server connected to a charge management system which comprises at least one or more user terminals, monitoring unit monitoring appliances configuring a network, and accounting unit calculating accounting information for the user terminal on the basis of a content distributing situation and permitting unit for determining whether the distribution of the content to the user terminal is permitted or not, and distributing a content to the user terminal, comprises, first changing unit changing dynamically a resolution rate of the content on the basis of a result of the monitoring by the monitoring unit, and wherein the accounting unit calculates the accounting information on the basis of the changed resolution rate of the content, and the monitoring unit monitors a content distribution condition affecting the content distribution, such as a change in a using band of the network, a fault situation of a port managed for every appliance, etc., and transmits, in case the content distribution condition changes, change information thereof to the permitting unit, and first receiving unit receiving indication of change the resolution rate on the basis of the change information from the permitting unit.

Further, a content distribution server according to the invention, further comprises second receiving unit receiving indication of adjustment a resolution rate of the selected content transmitted from the permitting unit, that the permitting unit selects the content distributed on a route shown by the change information.

Further, a content distribution server according to the invention, further comprises, first changing unit changing, based on an adjustment request received from the permitting unit, the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and first transmitting unit transmitting, to the permitting unit, resolution rate information of the content with its resolution rate changed and distribution destination user identifying information.

Further, a content distribution server according to the invention, further comprises second transmitting unit transmitting, when the distribution of the content is ended, the resolution rate change information and the distribution destination user identifying information to the permitting unit.

Further, in a content distribution server according to the invention, wherein the resolution rate change information through the dynamic resolution conversion which has been transmitted from the content distribution server makes the permitting unit transmitted, when the permitting unit received the resolution rate change information through the dynamic resolution conversion, the resolution rate information to the monitoring unit.

Further, in a content distribution server according to the invention, wherein the resolution rate information and distribution destination user identifying information of the content transmitted to the permitting unit from the content distribution server is transmitted to the monitoring unit, triggered by the end of the content distribution, by the permitting unit.

Further, a content distribution server according to the invention, further comprises second changing unit changing the encoding system through the dynamic encoding conversion from information of adjustment request received from the permitting unit, for ensuring the continuity of the service by adjusting a traffic quantity of the content distribution, preventing the disturbance of picture and keeping the condition worth listening to and watching.

Further, a charge management program applied to a content distribution server connected to a charge management system which comprises at least one or more user terminals, monitoring unit monitoring appliances configuring a network, and accounting unit calculating accounting information for the user terminal on the basis of a content distributing situation and permitting unit for determining whether the distribution of the content to the user terminal is permitted or not, and distributing a content to the user terminal, comprises, making the content distribution server functioned as first changing unit changing dynamically a resolution rate of the content on the basis of a result of the monitoring by the monitoring unit, and wherein the accounting unit calculates the accounting information on the basis of the changed resolution rate of the content, and the monitoring unit monitors a content distribution condition affecting the content distribution, such as a change in a using band of the network, a fault situation of a port managed for every appliance, etc., and transmits, in case the content distribution condition changes, change information thereof to the permitting unit, and making the content distribution server functioned as first receiving unit receiving indication of change the resolution rate on the basis of the change information from the permitting unit.

Further, a charge management program according to the invention, further comprises making the content distribution server functioned as second receiving unit receiving indication of adjustment a resolution rate of the selected content transmitted from the permitting unit, that the permitting unit selects the content distributed on a route shown by the change information.

Further, a charge management program according to the invention, further comprises making the content distribution server functioned as first changing unit changing, based on an adjustment request received from the permitting unit, the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and making the content distribution server functioned as first transmitting unit transmitting, to the permitting unit, resolution rate information of the content with its resolution rate changed and distribution destination user identifying information.

Further, a charge management program according to the invention, further comprises making the content distribution server functioned as second transmitting unit transmitting, when the distribution of the content is ended, the resolution rate change information and the distribution destination user identifying information to the permitting unit.

Further, in a charge management program according to the invention, wherein the resolution rate change information through the dynamic resolution conversion which has been transmitted from the content distribution server makes the permitting unit transmitted, when the permitting unit received the resolution rate change information through the dynamic resolution conversion, the resolution rate information to the monitoring unit.

Further, in a charge management program according to the invention, wherein the resolution rate information and distribution destination user identifying information of the content transmitted to the permitting unit from the content distribution server is transmitted to the monitoring unit, triggered by the end of the content distribution, by the permitting unit.

Further, a charge management program according to the invention, further comprises making the content distribution server functioned as second changing unit changing the encoding system through the dynamic encoding conversion from information of adjustment request received from the permitting unit, for ensuring the continuity of the service by adjusting a traffic quantity of the content distribution, preventing the disturbance of picture, and keeping the condition worth listening to and watching.

Further, a charge management system comprises, at least one or more user terminals, monitoring unit monitoring appliances configuring a network, distributing unit distributing a content to the user terminal, and accounting unit calculating accounting information for the user terminal on the basis of a content distributing situation, wherein the distributing unit dynamically changes a resolution rate of the content on the basis of a result of the monitoring by the monitoring unit, and the accounting unit calculates the accounting information on the basis of the changed resolution rate of the content.

Further, a charge management system according to the invention, further comprises permitting unit determining whether the distribution of the content to the user terminal is permitted or not, wherein the monitoring unit monitors a content distribution condition affecting the content distribution, such as a change in a using band of the network, a fault situation of a port managed for every appliance, etc., and transmits, in case the content distribution condition changes, change information thereof to the permitting unit, and the permitting unit indicates the distributing unit to change the resolution rate on the basis of the received change information.

Further, a charge management system according to the invention, wherein the permitting unit selects the content distributed on a route shown by the change information and indicates the distributing unit to adjust a resolution rate of the selected content.

Further, in a charge management system according to the invention, wherein the distributing unit, based on the adjustment request received from the permitting unit, changing the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and transmitting to the permitting unit, resolution rate information of the content with its resolution rate changed and distribution destination user identifying information.

Further, in a charge management system according to the invention, wherein the distributing unit transmits., when the distribution of the content is ended, the resolution rate change information and the distribution destination user identifying information to the permitting unit.

Further, in a charge management system according to the invention, wherein the permitting unit transmits, when receiving the resolution rate change information through the dynamic resolution conversion which has been transmitted from the distributing unit, the resolution rate information to the monitoring unit.

Further, in a charge management system according to the invention, wherein the permitting unit transmits, triggered by the end of the content distribution, to the monitoring unit the resolution rate information and the distribution destination user identifying information that have been received from the distributing unit.

Further, in a charge management system according to the invention, wherein the distributing unit receiving an adjustment request from the permitting unit and changing the encoding system through the dynamic encoding conversion from the information thereof, for ensuring the continuity of the service by adjusting a traffic quantity of the content distribution, preventing the disturbance of picture, and keeping the condition worth listening to and watching.

Further, in a charge management system according to the invention, wherein the accounting unit accumulates a degree of discount on the basis of a decrease quantity of the resolution rate and a distribution time in a decreased state, converts the degree of discount into a discount rate on a charge collection unit such as per end of month, etc., and calculates the accounting information by multiplying a standard charge by the discount rate.

According to the invention, it is feasible to continue the service without causing, though the deterioration in the resolution rate is recognized in the picture that is in the process of being listened to and watched, such a disturbance as to hinder the listening/watching, and to perform, in case the resolution of the distribution content deteriorates, the content charge discount service.

Note that the contents to be transmitted can include rich contents containing, e.g., image data in the invention.

Further, what the dynamic change of the resolution rate of the content connotes in the invention, implies changing the resolution rate, timely corresponding a result of the monitoring by the monitoring means.

Note that ┌resolution rate information of the content with its resolution rate changed and the distribution destination user identifying information┘ described in claim 4, etc. connote, for example, the information transmitted and received in S206 in FIG. 3, FIG. 20.

Further, ┌the resolution rate change information and the distribution destination user identifying information┘ described in claim 5, etc. connote, for instance, the information transmitted and received in S602 in FIG. 7, FIG. 21.

Moreover, ┌the resolution rate change information through the dynamic resolution conversion which has been transmitted from the distributing unit┘ described in claim 6, etc. connotes, for instance, the information transmitted and received in S405 in FIG. 5, FIG. 21.

Furthermore, ┌the resolution rate information┘ described in claim 6, etc. connotes, for example, the information transmitted and received in S406 in FIG. 5, FIG. 20.

Still further, ┌the resolution rate information and the distribution destination user identifying information that have been received from the distributing unit┘ described in claim 7, etc. connote, for instance, the information transmitted and received in S603 in FIG. 7, FIG. 20.

As the above, according to the invention, the user can continue to have the service without causing, though the deterioration in the resolution is recognized in the picture that is in the process of being listened to and watched, such a disturbance as to hinder the listening/watching, and, in case the resolution of the distribution content deteriorates, it is feasible to perform the content charge discount service.

### BRIEF DESCRIPTION OF THE DRAWINGS

FIG. 1 is a view of an architecture of a charge management system to which a first embodiment of the charge management method according to the invention is applied;

FIG. 2 is a conceptual view of a process starting with a content request of a user ending with distributing the requested content to the user in the first embodiment of the charge management method according to the invention;

FIG. 3 is a processing sequence diagram of the process shown in FIG. 2;

FIG. 4 is a conceptual view of a process till a dynamic change of a content resolution (traffic quantity) reaches the user when there occurs a change in a band of an IP network in the first embodiment of the charge management method according to the invention;

FIG. 5 is a processing sequence diagram of the process shown in FIG. 4;

FIG. 6 is a conceptual view of a process starting with an end of listening/watching of the content ending with a determination of a charge in the charge management system shown in FIG. 1;

FIG. 7 is a processing sequence diagram of the process shown in FIG. 6;

FIG. 8 is a conceptual view of an operation of a charge calculation system (intra charge center process) within the charge center shown in FIG. 6 in the first embodiment of the charge management method according to the invention;

FIG. 9 is a flowchart of an operation of a user terminal in the first embodiment of the charge management method according to the invention;

FIG. 10 is a flowchart of an operation of a Web portal server in the first embodiment of the charge management method according to the invention;

FIG. 11 is a flowchart of the operation of the Web portal server in the first embodiment of the charge management method according to the invention;

FIG. 12 is a flowchart of an operation of a subscriber information management server in the first embodiment of the charge management method according to the invention;

FIG. 13 is a flowchart of an operation of a content information management server in the first embodiment of the charge management method according to the invention;

FIG. 14 is a flowchart of an operation of a content distribution server in the first embodiment of the charge management method according to the invention;

FIG. 15 is a flowchart of an operation of a network monitor center in the first embodiment of the charge management method according to the invention;

FIG. 16 is a flowchart of an operation of a charge center in the first embodiment of the charge management method according to the invention;

FIG. 17 is a flowchart of an operation of a, M/C. EPON in the first embodiment of the charge management method according to the invention;

FIG. 18 is a flowchart of an operation of a router/SW in the first embodiment of the charge management method according to the invention;

FIG. 19 is a conceptual diagram of a data format of data used in the first embodiment of the charge management method according to the invention;

FIG. 20 is a conceptual diagram of a data format of data used in the first embodiment of the charge management method according to the invention;

FIG. 21 is a conceptual diagram of a data format of data used in the first embodiment of the charge management method according to the invention;

FIG. 22 is a conceptual diagram of a data format of data used in the first embodiment of the charge management method according to the invention;

FIG. 23 is a content selection sequence diagram in a second embodiment of the charge management method according to the invention;

FIG. 24 is a content encoding change sequence diagram in the second embodiment of the charge management method according to the invention;

FIG. 25 is a distribution information management sequence diagram in the second embodiment of the charge management method according to the invention;

FIG. 26 is a flowchart of a process on the side of the user terminal in the second embodiment of the charge management method according to the invention; and

FIG. 27 is a flowchart of a process on the side of the content distribution server in the second embodiment of the charge management method according to the invention.

### DETAILED DESCRIPTION OF THE PREFERRED EMBODIMENTS

### First Embodiment of Charge Management Method

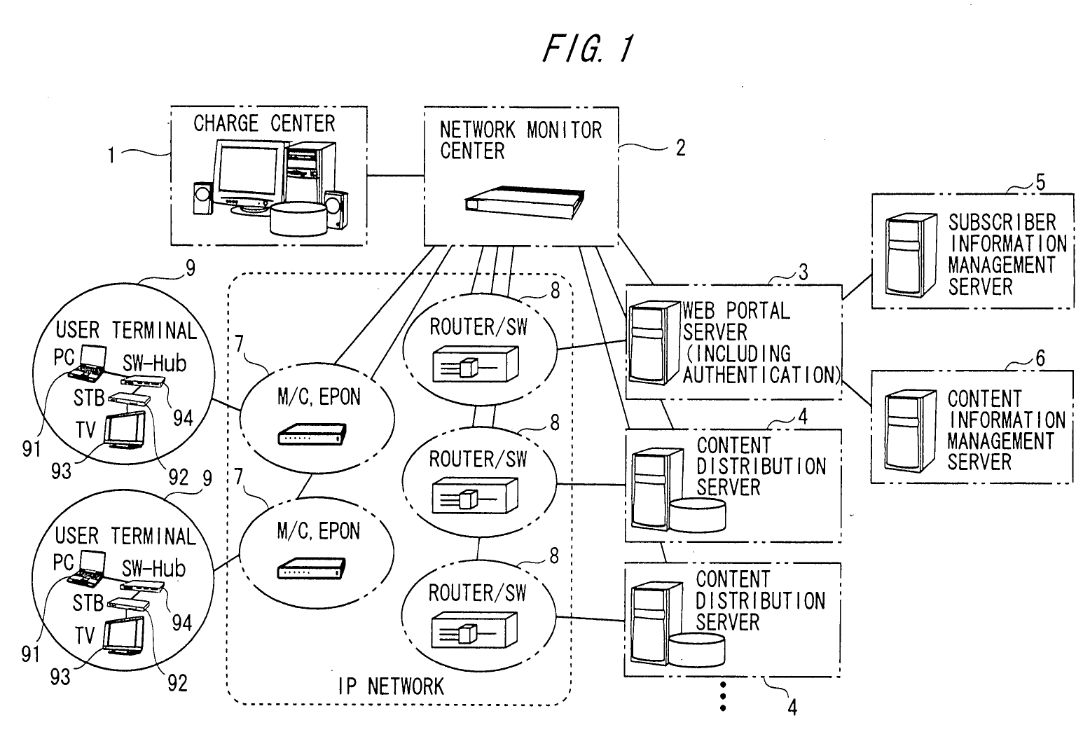

A first embodiment of a charge management method according to the invention will be explained with reference to the drawings. FIG. 1 is a view of an architecture of a charge management system to which the first embodiment of the charge management method according to the invention is applied. Note that in the following description, an explanation of each of the embodiments of the charge management method according to the invention serves as an explanation of each of embodiments of a charge device, a network monitor device, a Web portal server, a charge management program, a content distribution server and a charge management system according to the invention.

The invention is such that a content distribution server 4 as distribution means of contents dynamically controls a resolution of the content, a network monitor center 2 as monitor means unitarily monitors network appliances, and a charge center 1 as accounting means gathers pieces of accounting information with respect the content distributions.

A user terminal 9 is an in-home device provided with a streaming image receiving function for a picture content. Note that in the following description, there might be a case in which the user terminal is simply called a user.

In FIG. 1, as components the user terminal 9, it includes a PC (Personal Computer) 91, an STB (Set-top-box) 92 and a TV (television) 93, however, an information terminal capable of connecting to an IP network is an object as the user terminal 9, and further a wireless LAN connection is possible, though connected via a SW-HUB (Switching-Hub) 94 to the IP network.

The charge center 1 determines a charge to be collected in accordance with a contract condition with the user and a service providing situation. The charge center 1 is constructed including, for example, a server.

The network monitor center 2 manages an operation state (dynamic environment conditions such as a fault, a band, etc..) for every network configuring appliance. The network monitor center 2 is constructed including, for example, a server.

The Web portal server 3 manages an acceptance of a service request from the user, authentication and the service providing situation.

A subscriber information management server 5 manages subscription contract condition data for every user.

A content information management server 6 manages profile data (metadata) such as a content resolution, public conditions, etc. for every content.

The content distribution server 4 executes archiving of the content itself and a streaming distribution process.

A router/SW (Switch) 8 executes a layer-3 routing process.

A switch 7 such as an M/C (Media Converter), an EPON (Ether Passive Optical Network), etc. executes a switching process of layer-2.

The user terminal 9 is an in-home device having a streaming image receiving device for the picture content.

The content distribution server 4 is capable of dynamically controlling the resolution of the content and involves the use of a dynamic resolution conversion as means therefor.

In case deterioration occurs in a usable band on a distribution route for the content, the content distribution server 4 is notified of information thereon.

The content distribution server 4 reduces a traffic quantity in a way that changes, based on this piece of information, a resolution rate for the dynamic resolution conversion, and thus continues a content distribution service.

In the embodiment, the network monitor center 2 is installed as the monitor means for monitoring the appliances configuring the network, and the operation state (the dynamic environment conditions such as the fault, the band, etc.) is managed for every network configuring appliance.

Further, in the embodiment, the charge center 1 is installed as the accounting means for gathering the accounting information for the content distributions, and the charge to be collected is determined corresponding to the contract condition with the user and the service providing situation.

Note that the numbers of the respective appliances as illustrated in FIG. 1 are not limited to the numbers shown in FIG. 1 and may be an arbitrary number that is equal to or larger than at least 1.

1. Explanation of Content Selection (Streaming Distribution)

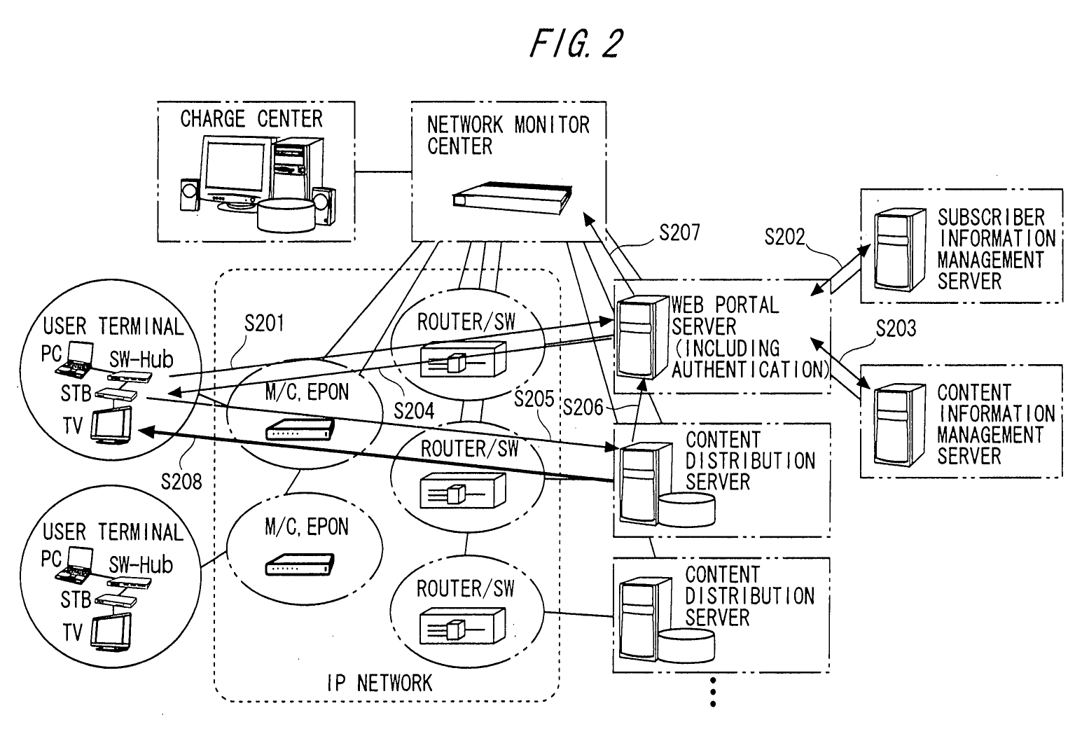

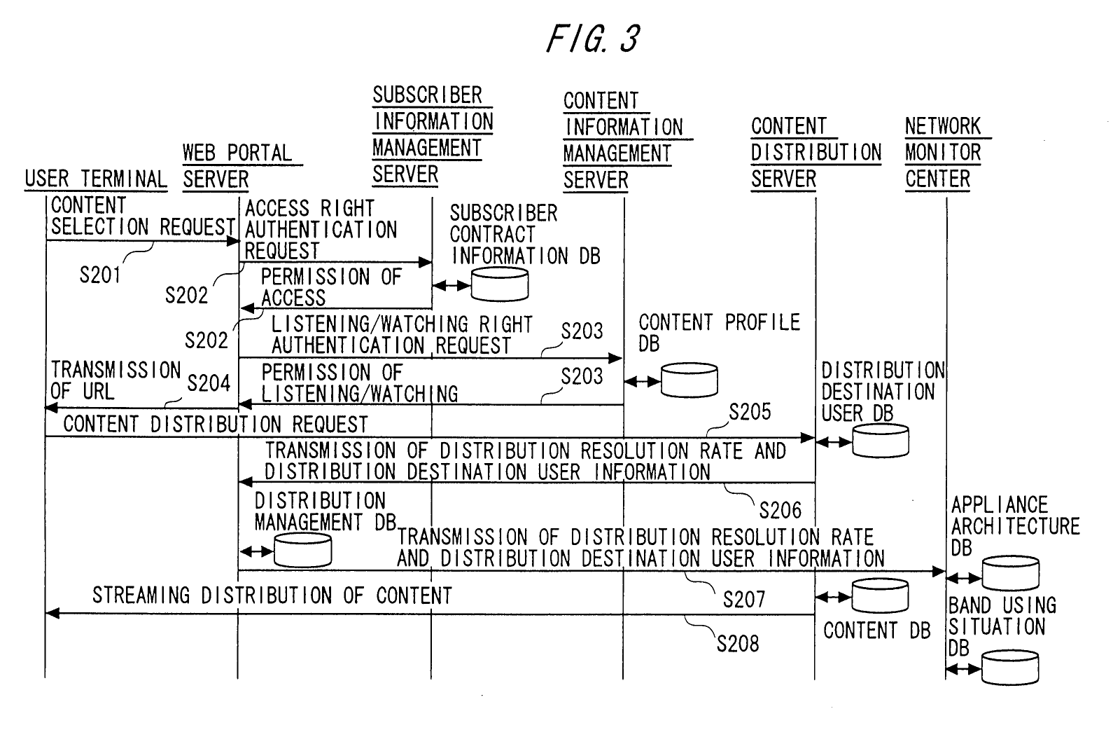

Next, an operation of the content selection (the streaming distribution) in the embodiment will be explained in greater detail. FIG. 2 shows a conceptual view of a process starting with a content request of the user ending with distributing the requested content to the user in the first embodiment of the charge management method according to the invention, and FIG. 3 shows a processing sequence diagram of the process shown in FIG. 2.

S201: The user terminal selects a want-to-listen-and-watch content from on an initial screen provided by the Web portal server, and makes a listening/watching request.

S202: The Web portal server that has received the listening/watching request gathers pieces of subscriber contract information management information of the user terminal from the subscriber information management server, and authenticates that the user has an access right to the service. The subscriber contract information management information is stored on a subscriber contract information DB.

S203: The Web portal server that has received the listening/watching request gathers pieces of profile management information of the content from the content information management server, and authenticates that the user has a listening/watching right to the selected content. The profile management information on the content is stored on a content profile DB.

S204: In case the authentication is rational, the Web portal server selects a content distribution server (which is a server having a maximum allowance in its processing capacity in the case of being plural) in which the selected content is accumulated, and notifies (redirection) the user of a URL of the content distribution server.

S205: The user terminal requests the content distribution server designated based on the URL information undergoing the redirection to distribute the selected content.

S206: The content distribution server notifies the Web portal server of a resolution rate (e.g., an MPEG2 compression 6 Mbps distribution) of the content distribution and distribution destination user information. The self-sever also manages the information. This piece of distribution destination user information is stored on a distribution destination user DB.

S207: The Web portal server manages the information by a distribution management DB, and notifies the network monitor center of it.

An appliance architecture of the network (which is a network topology) and a band using situation are managed in centralization by the network monitor center. These pieces of management data are stored on an appliance architecture DB and on a band using situation DB.

The network monitor center receiving the notification of the information dynamically reflects it in the management data of the band using situation.

S208: The content distribution server performs, as the notified information shows, the streaming distribution of the content stored on the content DB to the user. Herein, in case the distribution band having the resolution rate (e.g., the MPEG2 compression 6 Mbps distribution) designated by the content distribution server is not left in the network, distribution NG is sent back as a response to S206 and S207. In this case, the content distribution server gives, as a response to S205, a reply of being unable to distribute the content designated by the user as requested.

2. Description of Dynamic Change of Content Resolution (Traffic Quantity)

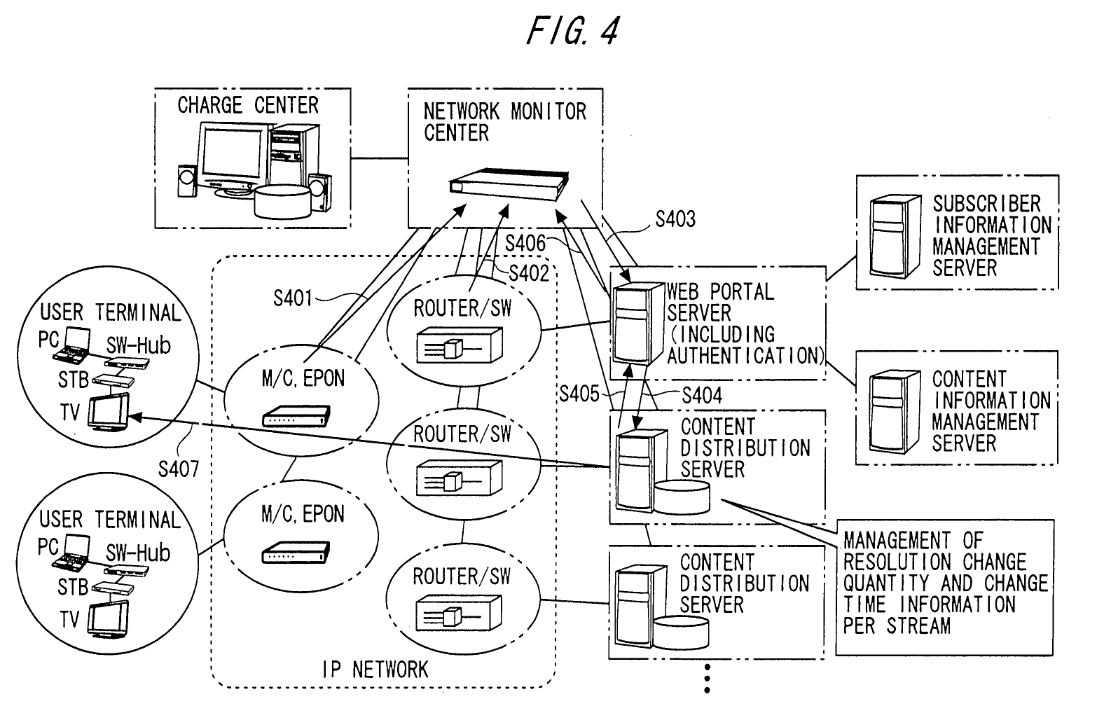

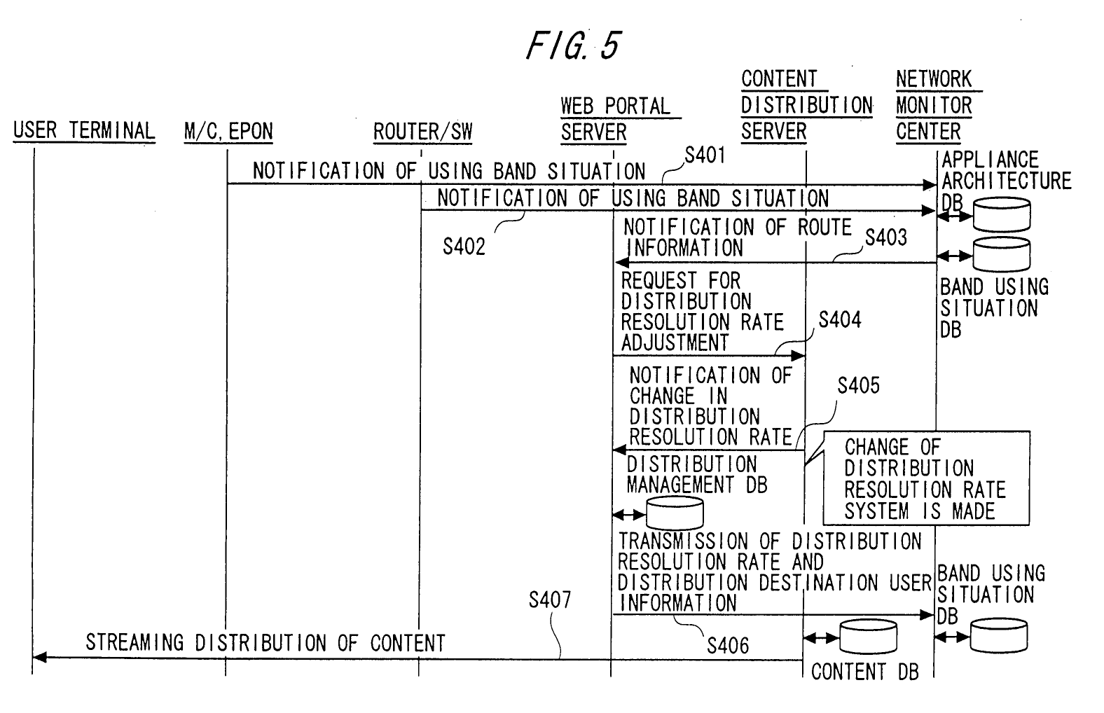

Next, A dynamic change of the content resolution (traffic quantity) in the embodiment will be explained referring to FIGS. 4 and 5.

FIG. 4 shows a conceptual view of a process till the dynamic change of the content resolution (traffic quantity) reaches the user when there occurs a change in the band of the IP network in the first embodiment of the charge management method according to the invention, and FIG. 5 shows a processing sequence diagram of the process shown in FIG. 4.

S401: The M/C, EPON notifies at any time the network monitor center of a change in the using band situation of M/C (Media converter) or EPON (Ether Passive Optical Network).

Herein, the M/C, EPON gives the notification whenever there changes the usable band (an influence on an in-use band, and a remaining band quantity) due to a traffic occurred other than the content distribution, a fault in a part of ports, and so on.

S402: The router/SW notifies at any time the network monitor center of a change in the using band situation of the router or the switch (SW).

Herein, the router/SW gives the notification whenever there changes the usable band (an influence on an in-use band, and a remaining band quantity) due to a traffic occurred other than the content distribution, a fault in a part of ports, and so on. Information on the architecture of the appliances and information on the band using situation are stored on the appliance architecture DB and on the band using situation DB.

S403: The network monitor center receiving the notifications in S401 and S402 notifies the Web portal server of information on a route where a situation affecting the distribution occurs on the route where the streaming distribution is conducted at that point of time.

S404: The Web portal server receiving the notification in S403 selects streaming information distributed on the route, and indicates the content distribution server to adjust (reduce) the resolution rate (traffic quantity) of each streaming by request.

This adjustment (reduction) request can involve using, for instance, the following two methods.

(1) The resolution rates (traffic quantities) of all the streaming that passes through the route are adjusted (reduced) uniformly.

(2) There is adjusted (reduced) of the resolution rate (traffic quantity) of only the streaming for the user (who does not establish a contract of a rate assurance) with the resolution rate adjustment permitted by referring to the subscription contract condition of the distribution destination user per streaming that passes through the route.

S405: The content distribution server, if capable of adjusting (reducing) the resolution rate (traffic quantity) according to the condition in S404, notifies the Web portal server of this purport and changes the distribution resolution rate of the streaming. If incapable of changing the resolution rate, it notifies of this purport.

S406: The Web portal server manages by itself the notified information in S405 by use of the distribution management DB, and notifies the network monitor center of it. The notified information is dynamically reflected in the monitor information stored on the band using situation DB.

S407: The content distribution server continues, according to the resolution rate adjusted (reduced), the streaming distribution of the content stored on the content DB.

3. Explanation of Management of Distribution Information (Notification of Charge Basic Information)

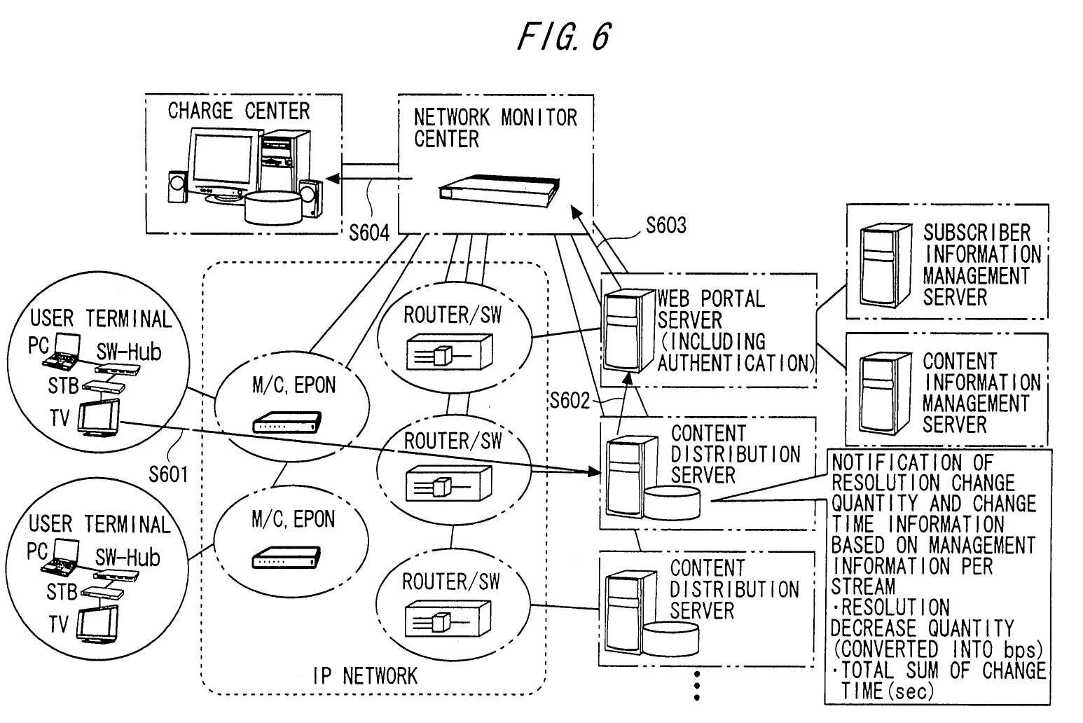

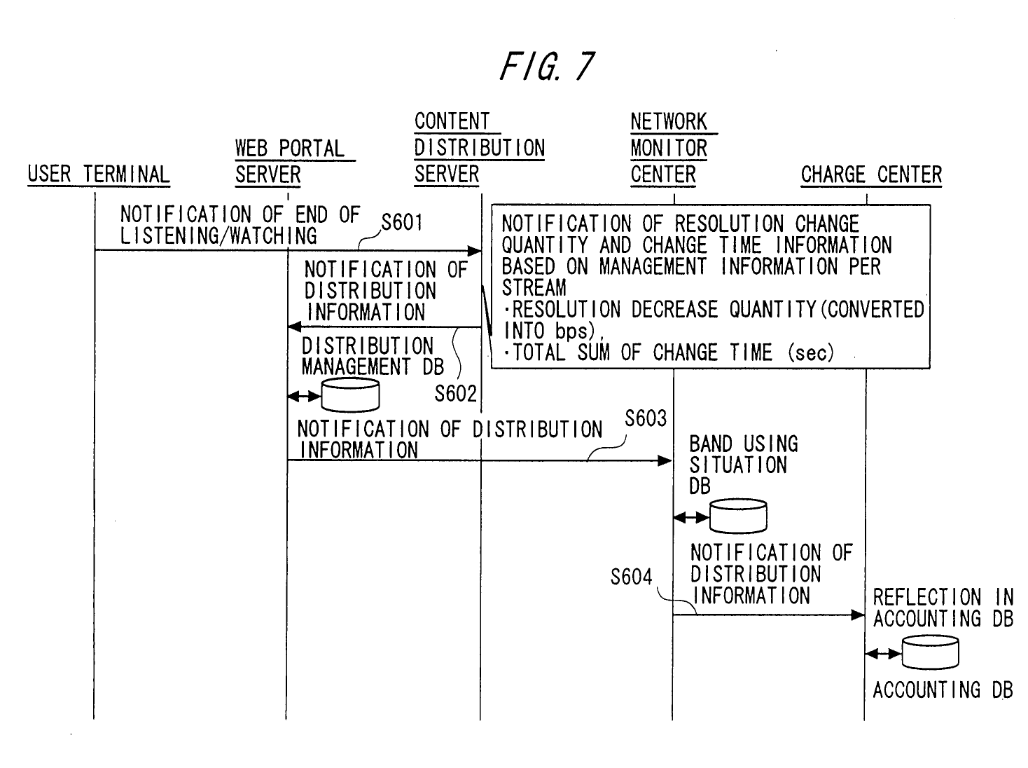

Next, a management of the distribution information (notification of charge basic information) in the embodiment, will be explained in greater detail. FIG. 6 shows a conceptual view of a process starting with an end of listening/watching of the content ending with a determination of a charge in the charge management system shown in FIG. 1, and FIG. 7 shows a sequence diagram of the process shown in FIG. 6.

S601: The content distribution server, an end notification of the listening/watching of the content being given from the user, terminates the streaming distribution. Alternatively, in case an auto reverse is not designated upon terminating the distribution of all the video contents in the process of being listened and watched by the user, the streaming distribution of the content is also automatically finished.

S602: The content distribution server, after the end of the streaming distribution, notifies the Web portal server of the information on the streaming distribution. The notified information is, for example, as follows. Further, the notified information is stored on the distribution management DB.

Streaming distribution destination user identifying information of the content

Resolution rate change (reduction) quantity: notification of a rate change quantity per unit time by a conversion into bps

Resolution rate change (reduction) executing time: unit time×N

Namely, there is notified of the resolution change quantity and the change time information on the basis of the management information per stream. For instance, a resolution decrease quantity is given as what is converted into bps, and a total sum of the change time is given in sec.

S603: The Web portal server reflects the end of the streaming distribution in its own management information, and notifies the network monitor center of the information obtained in S602.

S604: The network monitor center reflects the end of the streaming distribution in its own management information by use of the band using situation DB, and notifies the charge center of the information obtained in S603.

The charge center receiving the notification, in terms of calculating a charge on the user, calculates a degree of discount corresponding to the change (reduction) quantity of the resolution rate and a time on the basis of the information obtained in S603, and accumulates and manages it as a piece of charge collection information. This accumulation management is conducted by updating contents stored on the accounting DB provided in the charge center.

4. Explanation of Charge Calculation System (Intra Charge Center Process)

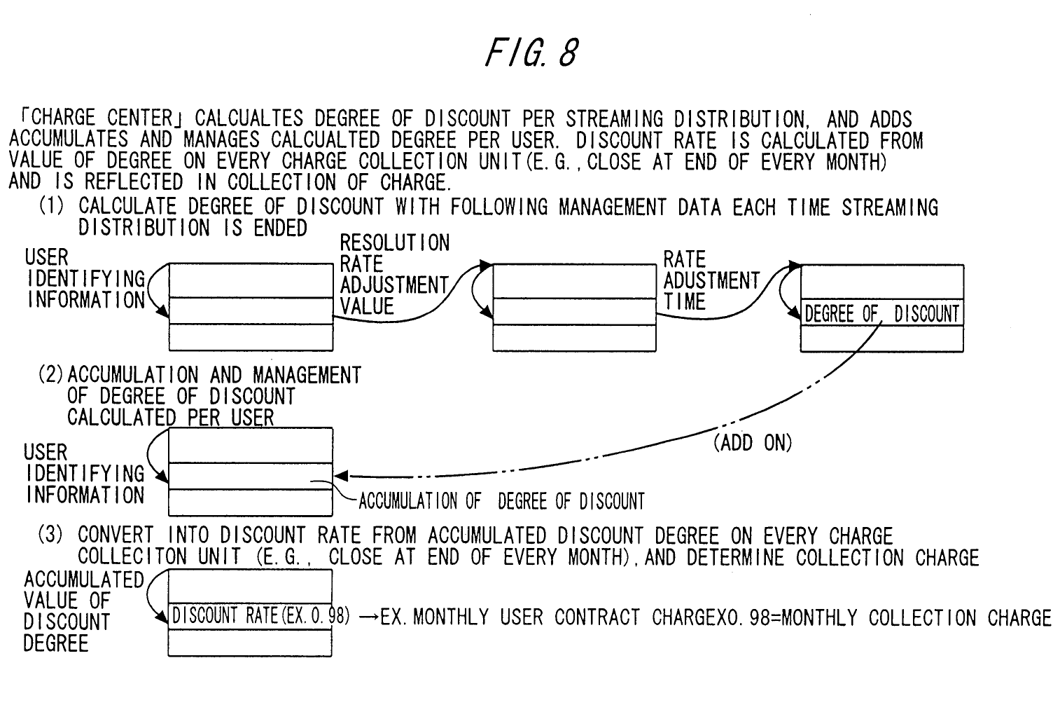

Next, a charge calculation system (intra charge center process) within the charge center shown in FIG. 6 will be explained referring to FIG. 8. FIG. 8 is a conceptual view of an operation of the charge calculation system (intra charge center process) within the charge center shown in FIG. 6 in the first embodiment of the charge management method according to the invention.

The charge center calculates the degree of discount for every streaming distribution, and adds, accumulates and manages the calculated degree for every user. Further, the charge center calculates discount rate from the value of degree per charge collection unit (e.g., a close at end of every month), and reflects it in the charge to be collected.

As shown in FIG. 8, to begin with, (1) each time the streaming distribution is ended, the degree of discount is calculated with the management data.

Namely, a resolution rate adjustment value is searched for from the user identifying information, and further a rate adjustment time is searched for, thereby calculating the degree of discount.

Then, (2) the degree of discount calculated for every user is accumulated and managed. That is, a new degree of discount, which is searched for from the user identifying information, is kept added to the already-calculated degree of discount.

Then, (3) the discount rate is converted from the accumulated degree of discount per charge collection unit (e.g., the close at the end of every month), and a charge to be collected is thus determined. For instance, if the discount rate is 0.98, a charge to be collected for the month is calculated by calculating such as the monthly user contract charge×0.98.

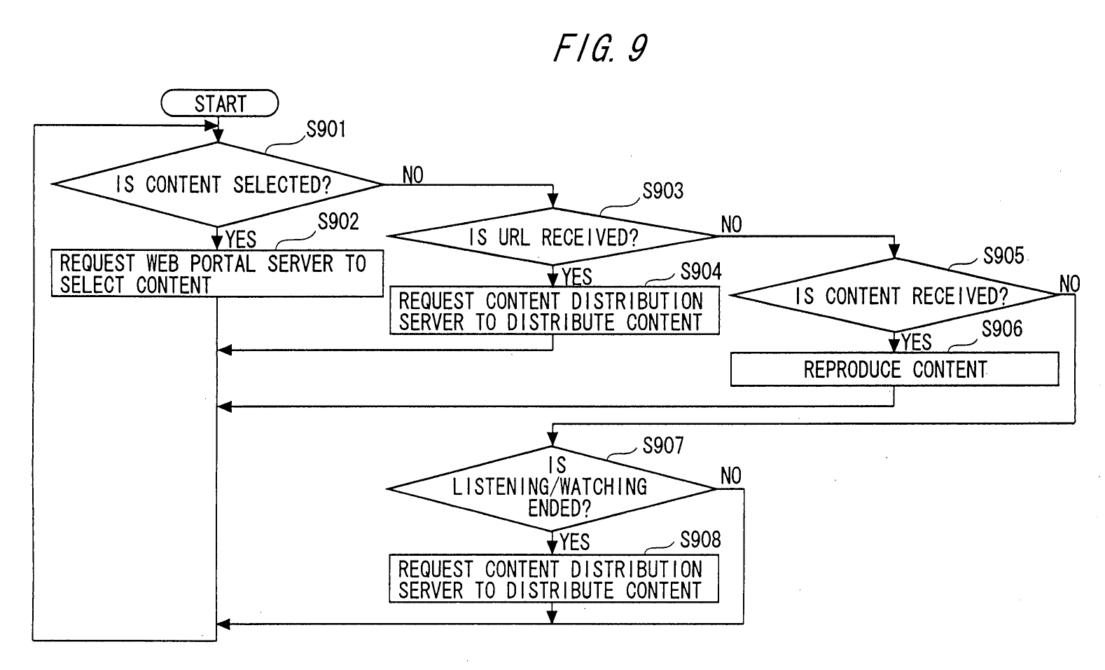

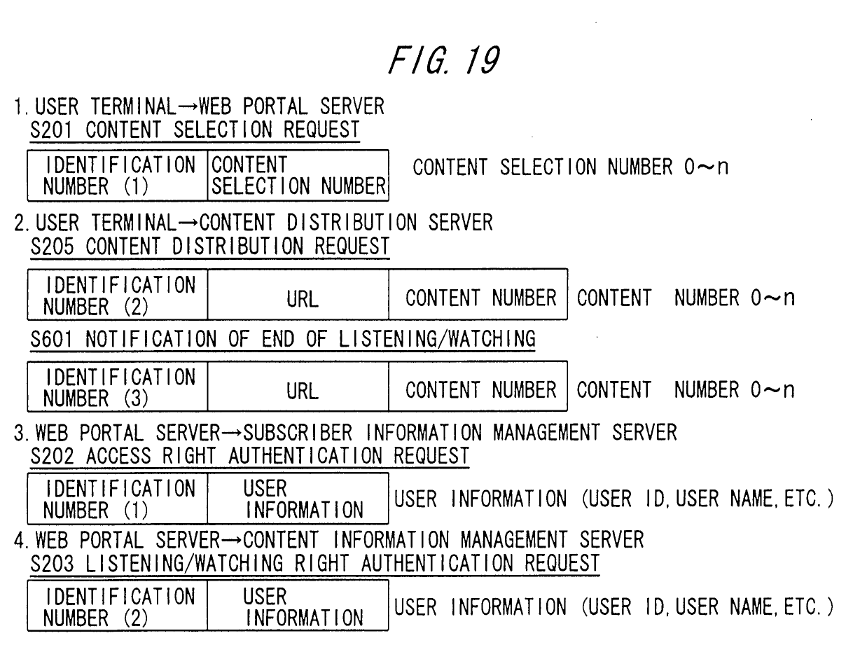

FIGS. 9 through 18 show flowcharts of the processes executed by the respective devices that have been described so far. Further, FIGS. 19 through 22 show structures of data transmitted and received between the devices.

(Operation of User Terminal)

Referring to FIG. 9, an operation of the user terminal in the embodiment will be explained. FIG. 9 is the flowchart of the operation of the user terminal in the first embodiment of the charge management method according to the invention.

To start with, the user terminal confirms whether the content is selected by the user or not (S901). If the content is selected (YES), the Web portal server is requested to select the content in S902, and, thereafter, there moves to S901.

While on the other hand, in the confirmation in S901, if the content is not selected (NO), there moves to S903, wherein it is confirmed whether the URL is received or not.

If the URL is received (YES), the content distribution server is requested to distribute in S904, and, thereafter, there moves to S901.

While on the other hand, in the confirmation in S903, if the URL is not received (NO), there moves to S905, wherein it is confirmed whether the content is received or not.

If the content is received (YES), there moves to S906, wherein the content is reproduced, and, thereafter, there moves to S901.

While on the other hand, in the confirmation in S905, if the content is not received (NO), there moves to S907, wherein it is confirmed whether the listening/watching is ended or not.

If the listening/watching is ended (YES), there moves to S908 in which the content distribution server is requested to distribute the content, and, thereafter, there moves to S901.

While on the other hand, in the confirmation in S907, if the listening/watching is not ended (NO), there moves to S901.

(Operation of Web Portal Server)

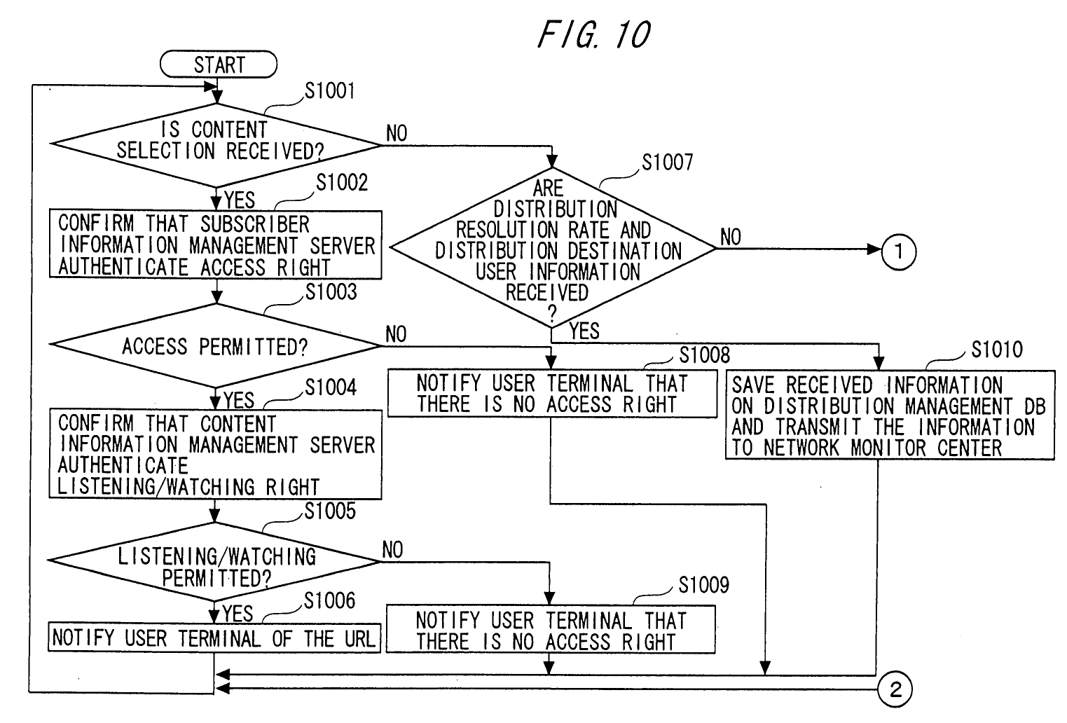

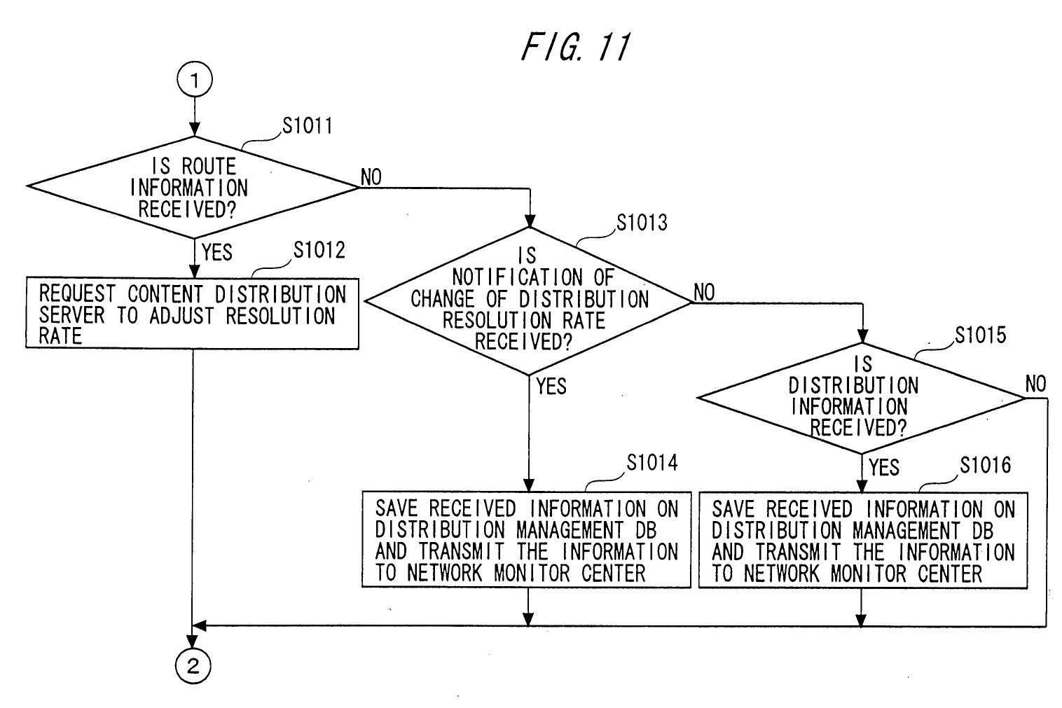

Next, an operation of the Web portal server in the embodiment will be explained with reference to FIGS. 10 and 11. FIGS. 10 and 11 are the flowcharts of the operation of the Web portal server in the first embodiment of the charge management method according to the invention.

At first, the Web portal server confirms in S1001 whether a content selection is received or not.

If the content selection is received (YES), there moves to S1002 in which the subscriber information management server is confirmed to authenticate the access right, and, thereafter, there moves to S1003.

In S1003, it is confirmed whether an access permission is given or not, if the access permission is given (YES), there moves to S1004 in which the content information management server is confirmed to authenticate the listening/watching right, and, thereafter, there moves to S1005.

In S1005, it is confirmed whether the listening/watching is permitted or not. If the listening/watching is permitted (YES), there moves to S1006 in which the user terminal is notified of the URL, and, thereafter, there moves to S1001.

While on the other hand, in the confirmation in S1001, if the content selection is not received (NO), there moves to S1007, wherein it is confirmed whether or not the distribution resolution rate and the distribution destination user information are received.

In the confirmation in S1007, if the distribution resolution rate and the distribution destination user information are received (YES), there moves to S1010.

In S1010, the received information is saved on the distribution management DB, the information is transmitted to the network monitor center, and, thereafter, there moves to S1001.

While on the other hand, in the confirmation in S1003, if the access permission is not given (NO), there moves to S1008 in which the user terminal is notified of having no access right, and, thereafter, there moves to S1001.

While on the other hand, in the confirmation in S1005, the listening/watching is not permitted (NO), there moves to S1009 in which the user terminal is notified of having no access right, and, thereafter, there moves to S1001.

While on the other hand, in the confirmation in S1007, the distribution resolution rate and the distribution destination user information are not received (NO), and there moves to S1011 shown in FIG. 11, wherein it is confirmed whether route information is received or not.

If the route information is received (YES), there moves to S1012 in which the content distribution server is requested to adjust the resolution rate, and, thereafter, there moves to S1001 shown in FIG. 10.

While on the other hand, in the confirmation in S1011, if the route information is not received (NO), there moves to S1013, wherein it is confirmed whether a notification of a change of distribution resolution rate is received or not.

If the notification of the change of distribution resolution rate is received (YES), the moves to S1014 in which the received information is saved on the distribution management DB and the information is transmitted to the network monitor center, and, thereafter, there moves to S1001 shown in FIG. 10.

While on the other hand, in the confirmation in S1013, if the notification of the change of distribution resolution rate is not received (NO), there moves to S1015, wherein it is confirmed whether the distribution information is received or not.

If the distribution information is received (YES), there moves to S1016 in which the received information is saved on the distribution management DB and the information is transmitted to the network monitor center, and, thereafter, there moves to S1001 shown in FIG. 10.

While on the other hand, if the distribution information is not received (NO), there moves to S1001 shown in FIG. 10.

(Operation of Subscriber Information Management Server)

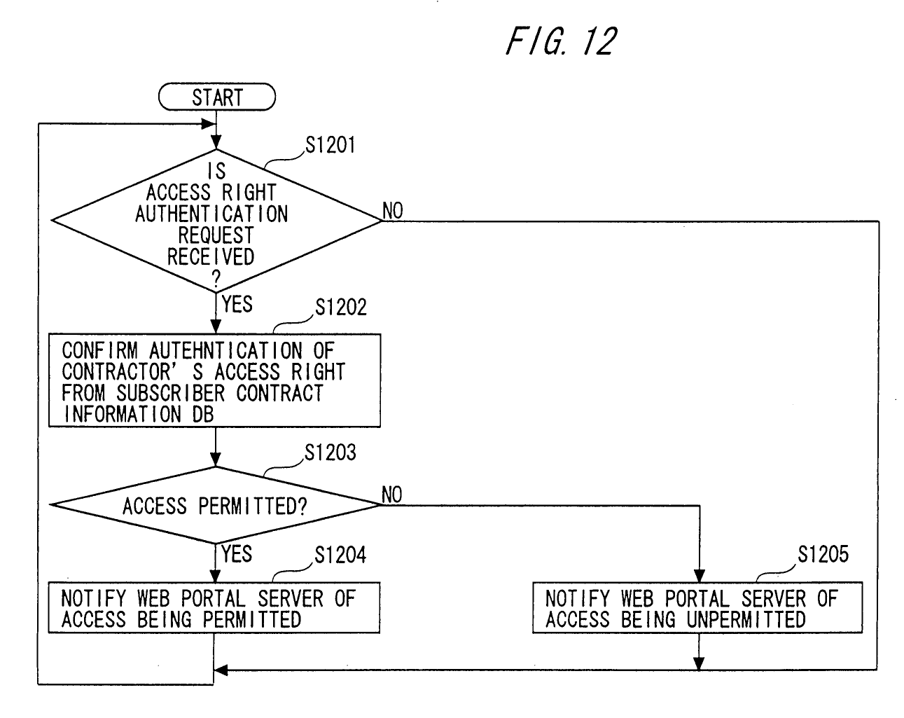

Next, referring to FIG. 12, an operation of the subscriber information management server in the embodiment will be described. FIG. 12 is the flowchart of the operation of the subscriber information management server in the first embodiment of the charge management method according to the invention.

To begin with, the subscriber information management server confirms whether an access right authentication request is received or not (S1201).

The subscriber information management server, if the access right authentication request is received (YES), moves to S1202, and confirms the authentication of the access right of a contractor from the subscriber contract information DB.

In S1203, it is confirmed whether the access permission is given or not, if the access permission is given (YES), there moves to S1204 in which the Web portal server is notified of the access permission, and, thereafter, there moves to S1201.

While on the other hand, in the confirmation in S1201, if a listening/watching right authentication request is not received (NO), there comes to a standby status for the listening/watching right authentication request.

While on the other hand, in the confirmation in S1203, if the access permission is not given (NO), there moves to S1205 in which the Web portal server is notified of the access being unpermitted, and, thereafter, there moves to S1201.

(Operation of Content Information Management Server)

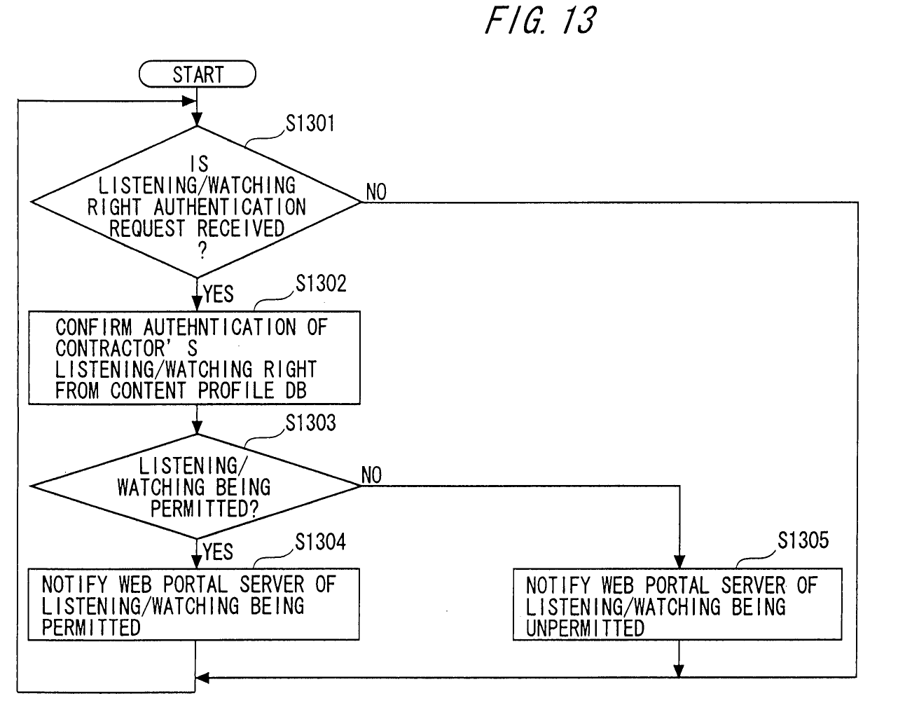

Next, referring to FIG. 13, an operation of the content information management server in the embodiment will be described. FIG. 13 is the flowchart of the operation of the content information management server in the first embodiment of the charge management method according to the invention.

To start with, the content information management server confirms whether listening/watching right authentication request is received or not (S1301).

If the listening/watching right authentication request is received (YES), there moves to S1302 in which the authentication of the listening/watching right of the contractor is confirmed from the content profile DB, and, thereafter, there moves to S1303.

In S1303, it is confirmed whether the listening/watching permission is given or not, if the listening/watching permission is given (YES), there moves to S1304 in which the Web portal server is notified of the listening/watching permission, and, thereafter, there moves to S1301.

While on the other hand, in the confirmation in S1301, if the listening/watching right authentication request is not received (NO), there comes to the standby status for the listening/watching right authentication request.

While on the other hand, in the confirmation in S1303, if the listening/watching permission is not given (NO), there moves to S1305 in which the Web portal server is notified of the listening/watching being unpermitted, and, thereafter, there moves to S1301.

(Operation of Content Distribution Server)

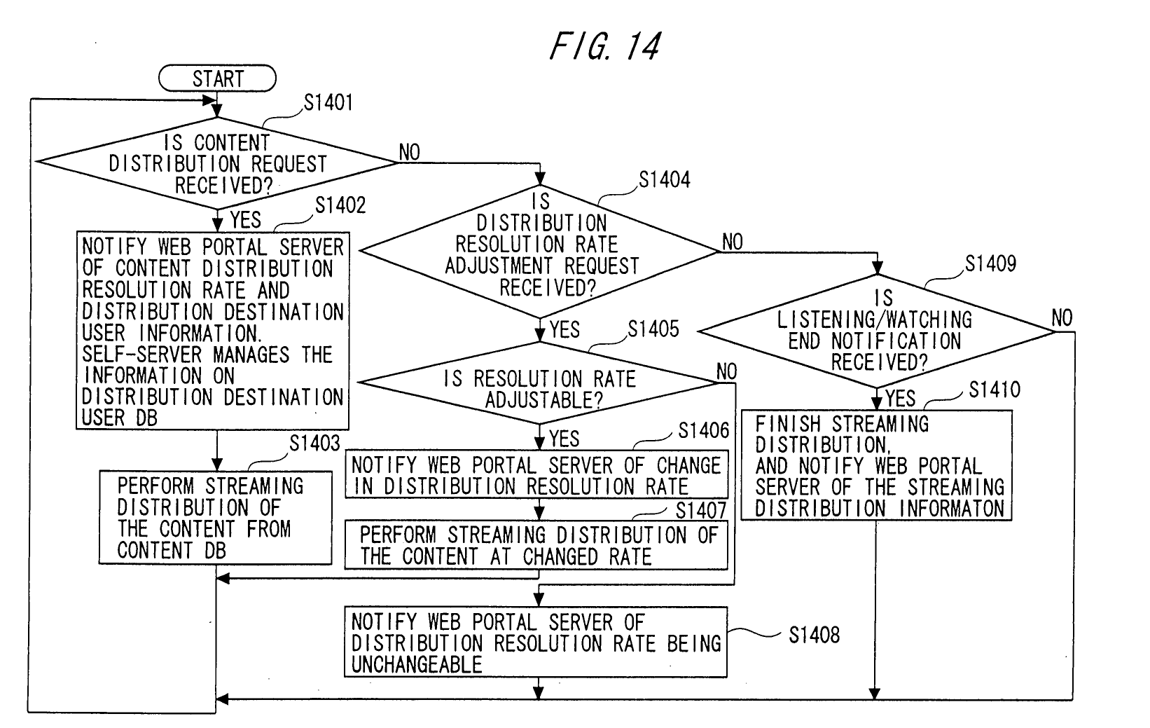

Next, referring to FIG. 14, an operation of the content distribution server in the embodiment will be described. FIG. 14 is the flowchart of the operation of the content distribution server in the first embodiment of the charge management method according to the invention.

At first, the content distribution server confirms whether a content distribution request is received or not (S1401).

The content distribution server, if the content distribution request is received (YES), moves to S1402, and notifies the Web portal server of a content distribution resolution rate and distribution destination user information. The self-server also manages the information on the distribution destination user DB.

Thereafter, the content distribution server, in S1403, does the streaming distribution of the content from the content DB, and thereafter moves to S1401.

While on the other hand, in the confirmation in S1401, in case the content distribution request is not received (NO), there moves to S1404.

In S1404, it is confirmed whether a distribution resolution rate adjustment request is received or not.

If the distribution resolution rate adjustment request is received (YES), in S1405, it is confirmed whether the resolution rate adjustment is possible or not.

If the resolution rate adjustment is possible (YES), there moves to S1406, and the Web portal server is notified of a change in the distribution resolution rate.

Then, there moves to S1407 in which the streaming distribution of the content is performed at the changed rate, and, thereafter, there moves to S1401.

While on the other hand, in the confirmation in S1405, if the resolution rate adjustment is not possible (NO), there moves to S1408 in which the Web portal server is notified of being impossible of changing the distribution resolution rate, and, thereafter, there moves to S1401.

While on the other hand, in the confirmation in S1404, if the distribution resolution rate adjustment request is not received (NO), there moves to S1409, wherein it is confirmed whether or not a listening/watching end notification is received or not.

If the listening/watching end notification is received in the confirmation in S1409 (YES), there moves to S1410 in which the streaming distribution is finished and a notification of the streaming distribution information is given to the Web portal server, and thereafter there moves to S1401.

While on the other hand, if the listening/watching end notification is not received in the confirmation in S1409 (NO), there moves to S1401.

(Operation of Network Monitor Center)

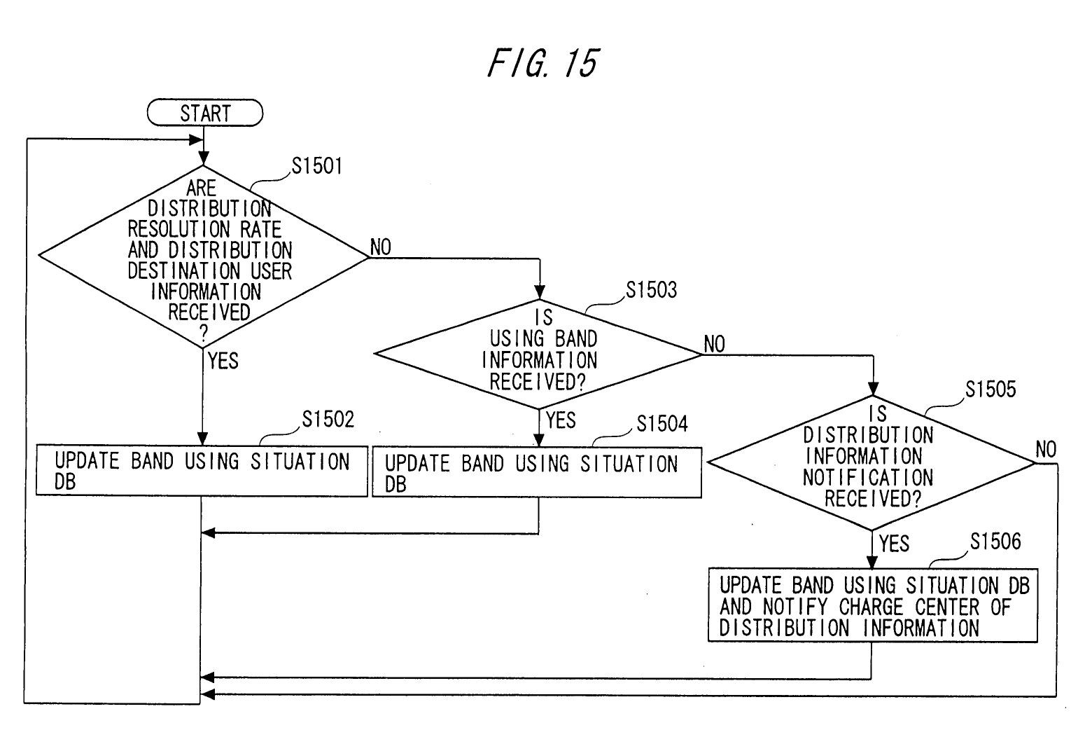

Next, referring to FIG. 15, an operation of the network monitor center in the embodiment will be described. FIG. 15 is the flowchart of the operation of the network monitor center in the first embodiment of the charge management method according to the invention.

The network monitor center, at first, in S1501, confirms whether or not the distribution resolution rate and the distribution destination user information are received.

Then, the network monitor center, if the distribution resolution rate and the distribution destination user information are received (YES), moving to S1502, updates the band using situation DB, and thereafter moves to S1501.

While on the other hand, in the confirmation in S1501, if the distribution resolution rate and the distribution destination user information are not received (NO), there moves to S1503, wherein it is confirmed whether the using band information is received or not.

Then, if the using band information is received (YES), there moves to S1504 in which the band using situation DB is updated, and, thereafter, there moves to S1501.

While on the other hand, if the using band information is not received (NO), there moves to S1505, wherein it is confirmed whether a distribution information notification is received or not.

If the distribution information notification is received (YES), there moves to S1506 in which the band using situation DB is updated and the charge center is notified of the distribution information, and, thereafter, there moves to S1501.

While on the other hand, in the confirmation in S1505, if the distribution information notification is not received (NO), there moves to S1501.

(Operation of Charge Center)

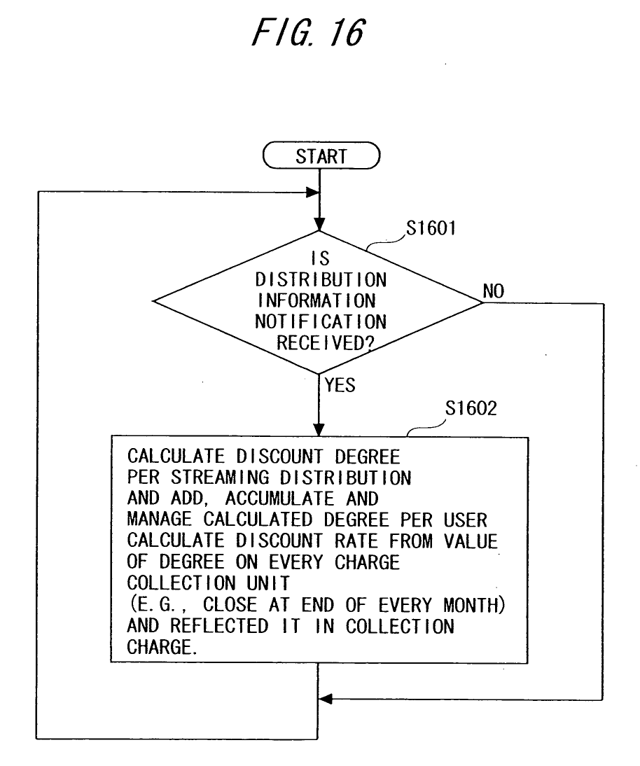

Next, referring to FIG. 16, an operation of the charge center in the embodiment will be described. FIG. 16 is the flowchart of the operation of the charge center in the first embodiment of the charge management method according to the invention.

The charge center, to start with, in S1601, confirms whether the distribution information notification is received or not.

Then, if the distribution information notification is received (YES), there moves to S1602, wherein a degree of discount is calculated for every streaming distribution, and the calculated degree is added, accumulated and managed per user. A discount rate is calculated from the value of the degree per charge collection unit (e.g., a close at the end of every month) and is reflected in a charge to be collected.

If the distribution information notification is not received (NO), there is a standby status till the distribution information notification is received.

(Operation of M/C, EPON)

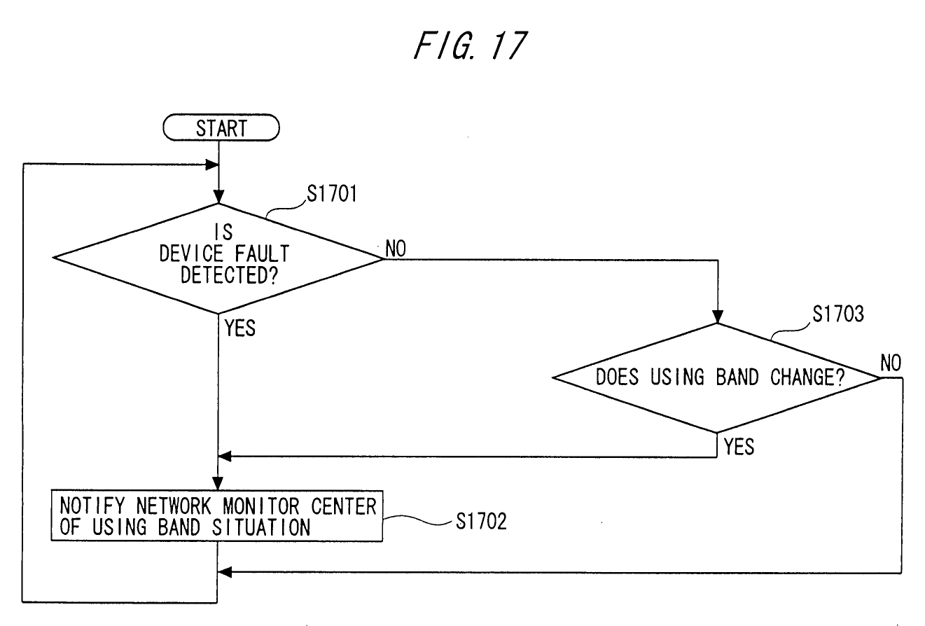

Next, referring to FIG. 17, an operation of the M/C, EPON in the embodiment will be described. FIG. 17 is the flowchart of the operation of the M/C, EPON in the first embodiment of the charge management method according to the invention.

To begin with, the M/C, EPON confirms in S1701 whether a device fault is detected or not.

If the device fault is detected (YES), there moves to S1702 in which the network monitor center is notified of a using band situation, and, thereafter, there moves to S1701.

In the confirmation in S1701, if the device fault is not detected (NO), there moves to S1703.

In S1703, it is confirmed whether a using band change occurs or not.

In case the using band change occurs (YES), there moves to S1702.

In case the using band change does not occur (NO), there moves to S1701.

(Operation of Router/SW)

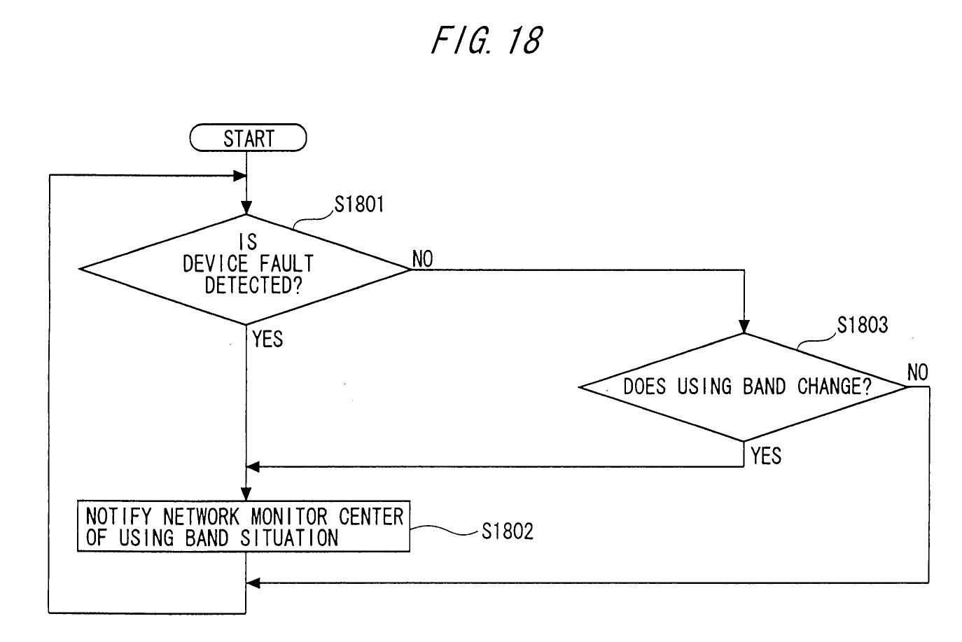

Next, referring to FIG. 18, an operation of the router/SW in the embodiment will be described. FIG. 18 is the flowchart of the operation of the router/SW in the first embodiment of the charge management method according to the invention.

At first, the router/SW confirms in S1801 whether a device fault is detected or not.

If the device fault is detected (YES), there moves to S1802 in which the network monitor center is notified of a using band situation, and, thereafter, there moves to S1801.

In the confirmation in S1801, if the device fault is not detected (NO), there moves to S1803.

In S1803, it is confirmed whether a using band change occurs or not.

In case the using band change occurs (YES), there moves to S1802.

In case the using band change does not occur (NO), there moves to S1801.

Next, data formats of the data used in the charge management system shown in FIG. 1 will be explained referring to FIGS. 19 through 22. FIGS. 19 through 22 are conceptual diagrams of the data formats of the data used in the first embodiment of the charge management method according to the invention.

1. Data Transmitted to the Web Portal Server from the User Terminal

The data transmitted to the Web portal server from the user terminal in S201 in FIG. 2 contain, as shown in FIG. 19, an identification number and a content selection number. The content selection number takes a value of 0 through n.

2. Data Transmitted to the Content Distribution Server from the User Terminal

The data transmitted to the content distribution server from the user terminal in S205 in FIG. 2 contain, as shown in FIG. 19, an identification number, a URL and a content number. The content number takes a value of 0 through n.

The data transmitted to the content distribution server from the user terminal in S601 in FIG. 6 contain an identification number, a URL and a content number. The content number takes a value of 0 through n.

3. Data Transmitted to the Subscriber Information Management Server from the Web Portal Server

The data transmitted to the subscriber information management server from the Web portal server in S202 in FIG. 2 contain, as shown in FIG. 19, an identification number and user information. The user information contains a user ID, a user name and so on.

4. Data Transmitted to the Content Information Management Server from the Web Portal Server

The data transmitted to the content information management server from the Web portal server in S203 in FIG. 2 contain, as shown in FIG. 19, an identification number and user information. The user information contains a user ID, a user name and so on.

5. Data Transmitted to the Network Monitor Center from the Web Portal Server

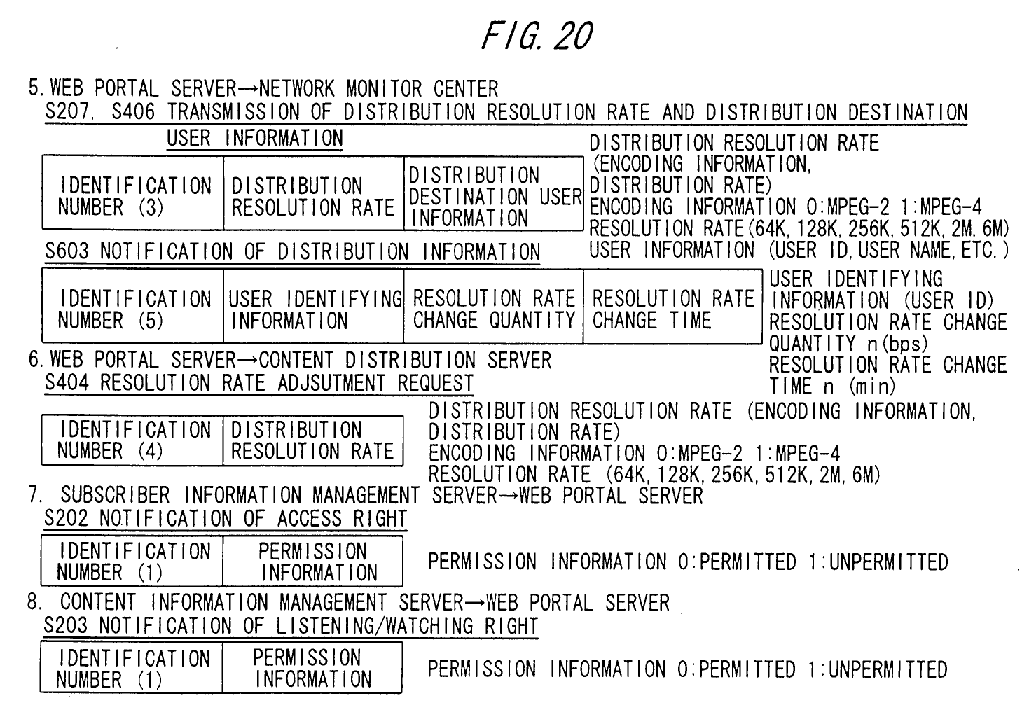

The data transmitted to the network monitor center from the Web portal server in S207 in FIG. 2 and in S406 in FIG. 4 contain, as shown in FIG. 20, an identification number, a distribution resolution rate and distribution destination user information. The distribution resolution rate consists of encoding information and a distribution rate. The encoding information is such as 0:MPEG-2, 1:MPEG-4, etc.. The resolution rate is such as 64K, 128K, 512K, 2M, 6M, etc.. The user information contains a user ID, a user name and so on.

The data transmitted to the network monitor center from the Web portal server in S603 in FIG. 6 contain, as shown in FIG. 20, an identification number, user identifying information, a resolution rate change quantity and a resolution rate change time. The user identifying information consists of a user ID. The resolution rate change quantity consists of n (bps), and the resolution rate change time consists of n (min).

6. Data Transmitted to the Content Distribution Server from the Web Portal Server

The data transmitted to the content distribution server from the Web portal server in S404 in FIG. 4 contain, as shown in FIG. 20, an identification number and a distribution resolution rate. The distribution resolution rate consists of encoding information and a distribution rate. The encoding information is such as 0:MPEG-2 and 1:MPEG-4. The resolution rate is such as 64K, 128K, 512K, 2M, 6M, etc..

7. Data Transmitted to the Web Portal Server from the Subscriber Information Management Server

The data transmitted to the Web portal server from the subscriber information management server in S202 in FIG. 2 consist of, as shown in FIG. 20, an identification number and permission information. The permission information contains 0: permitted and 1: unpermitted.

8. Data Transmitted to the Web Portal Server from the Content Information Management Server

The data transmitted to the Web portal server from the content information management server in S203 in FIG. 2 consist of, as shown in FIG. 20, an identification number and permission information. The permission information contains 0: permitted and 1: unpermitted.

9. Data Transmitted to the Web Portal Server from the Content Distribution Server

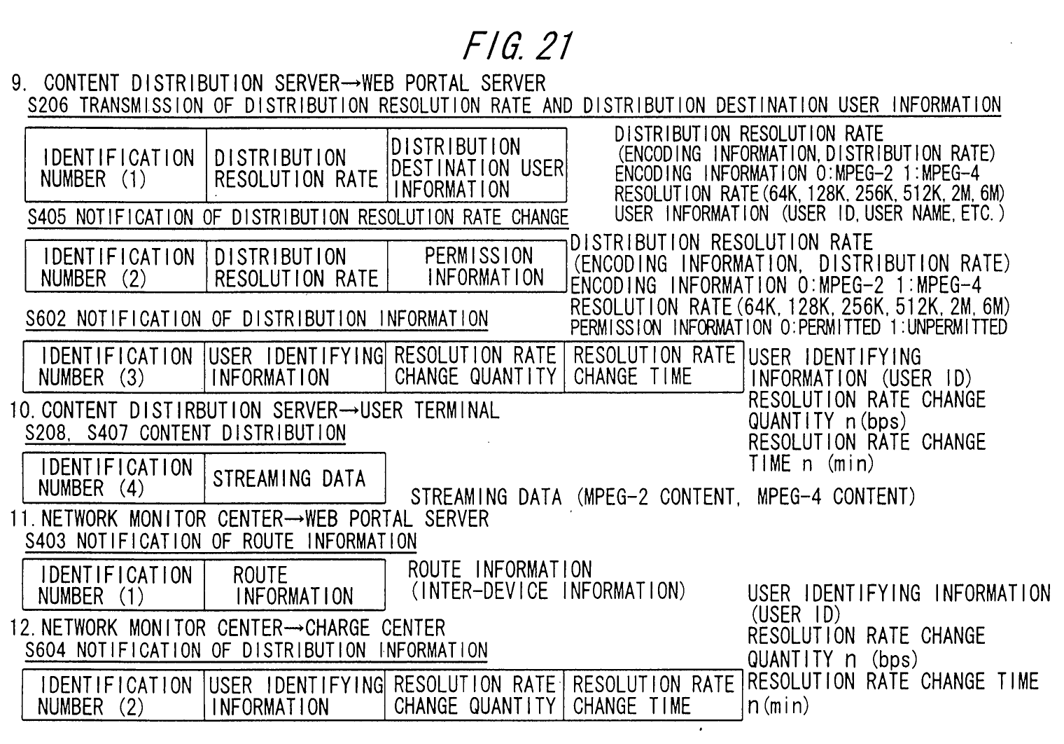

The data transmitted to the Web portal server from the content distribution server in S206 in FIG. 2 contain, as shown in FIG. 21, an identification number, a distribution resolution rate and distribution destination user information. The distribution resolution rate consists of encoding information and a distribution rate. The encoding information is such as 0:MPEG-2 and 1:MPEG-4. The resolution rate is such as 64K, 128K, 512K, 2M, 6M, etc.. The user information contains a user ID, a user name and so on.

The data transmitted to the Web portal server from the content distribution server in S405 in FIG. 4 contain, as shown in FIG. 21, an identification number, a distribution resolution rate and permission information. The distribution resolution rate consists of encoding information and a distribution rate. The encoding information is such as 0:MPEG-2 and 1:MPEG-4. The resolution rate is such as 64K, 128K, 512K, 2M, 6M, etc.. The permission information is such as 0: permitted and 1: unpermitted.

The data transmitted to the Web portal server from the content distribution server in S602 in FIG. 6 contain, as shown in FIG. 21, an identification number, user identifying information, a resolution rate change quantity and a resolution rate change time. The user identifying information consists of a user ID. The resolution rate change quantity consists of n (bps), and the resolution rate change time consists of n (min).

10. Data Transmitted to the User Terminal from Content Distribution Server

The data transmitted to the user terminal from content distribution server in S208 in FIG. 2 and in S407 in FIG. 4 consist of, as shown in FIG. 21, an identification number and streaming data. The streaming data consist of MPEG-2 contents and MPEG-4 contents.

11. Data Transmitted to the Web Portal Server from the Network Monitor Center

The data transmitted to the Web portal server from the network monitor center in S403 in FIG. 4 consist of, as shown in FIG. 21, an identification number and route information. The route information consists of pieces of inter-device information.

12. Data Transmitted to the Charge Center from the Network Monitor Center

The data transmitted to the charge center from the network monitor center in S604 in FIG. 6 contain, as shown in FIG. 21, an identification number, user identifying information, a resolution rate change quantity and a resolution rate change time. The user identifying information consists of a user ID. The resolution rate change quantity consists of n (bps), and the resolution rate change time consists of n (min).

13. Data Transmitted to the Network Monitor Center from the M/C, EPON

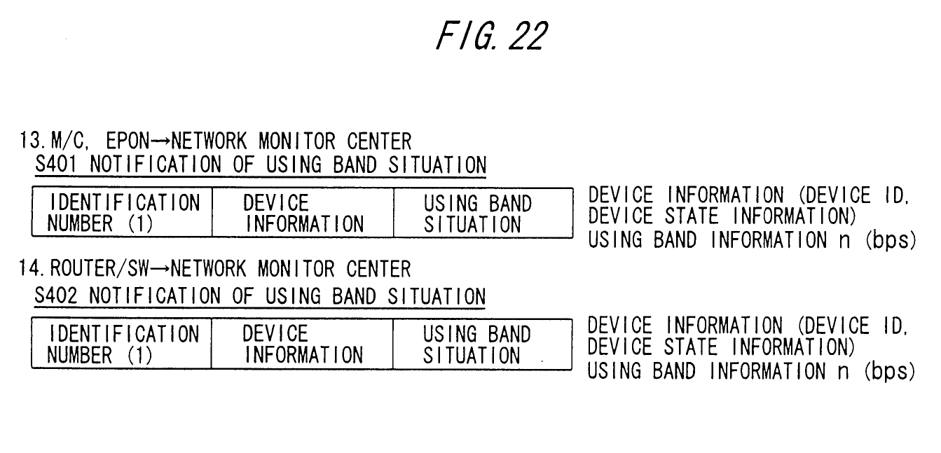

The data transmitted to the network monitor center from the M/C, EPON in S401 in FIG. 4 contain, as shown in FIG. 22, identifying information, device information and using band information. The device information contains a device ID and device state information. The using band information is composed of n (bps).

14. Data Transmitted to the Network Monitor Center from the Router/SW

The data transmitted to the network monitor center from the router/SW in S402 in FIG. 4 contain, as shown in FIG. 22, identifying information, device information and using band information. The device information contains a device ID and device state information. The using band information is composed of n (bps).

As described above, in accordance with the first embodiment of the charge management method according to the invention, even in the case where the fault occurs in the appliances configuring the network, the content distribution server 4 changes, based on the instruction of the Web portal server 3, the resolution rate, and hence the user can continue enjoying the service without causing, though the deterioration in the resolution rate is recognized in the picture that is in the process of being listened to and watched, such a disturbance as to hinder the listening/watching, and further the charge center 1 charges money corresponding to the resolution rate and is capable of, in case the resolution of the distribution content deteriorates, performing the content charge discount service.

### Second Embodiment of Charge Management Method

Next, a second embodiment of the charge management method according to the invention will be explained with reference to the drawings.

The dynamic resolution conversion (DRC) aims at the same streaming, however, there exists a case in which the processing can not be completely done only by the dynamic resolution conversion due to a deficiency of band of the IP network.

Then, in the embodiment, the content distribution server is provided with a process of switching over the encoding system during the streaming to MPEG-4 from MPEG-2 and switching over it back to MPEG-2 from MPEG-4 when the band of the IP network is sufficiently ensured, thereby continuing the service, and, in case the resolution of the distribution content deteriorates, the content charge discount service is carried out.

Note that the configuration and the data format in the embodiment are substantially the same as those in the first embodiment, and hence their detailed explanations are omitted.

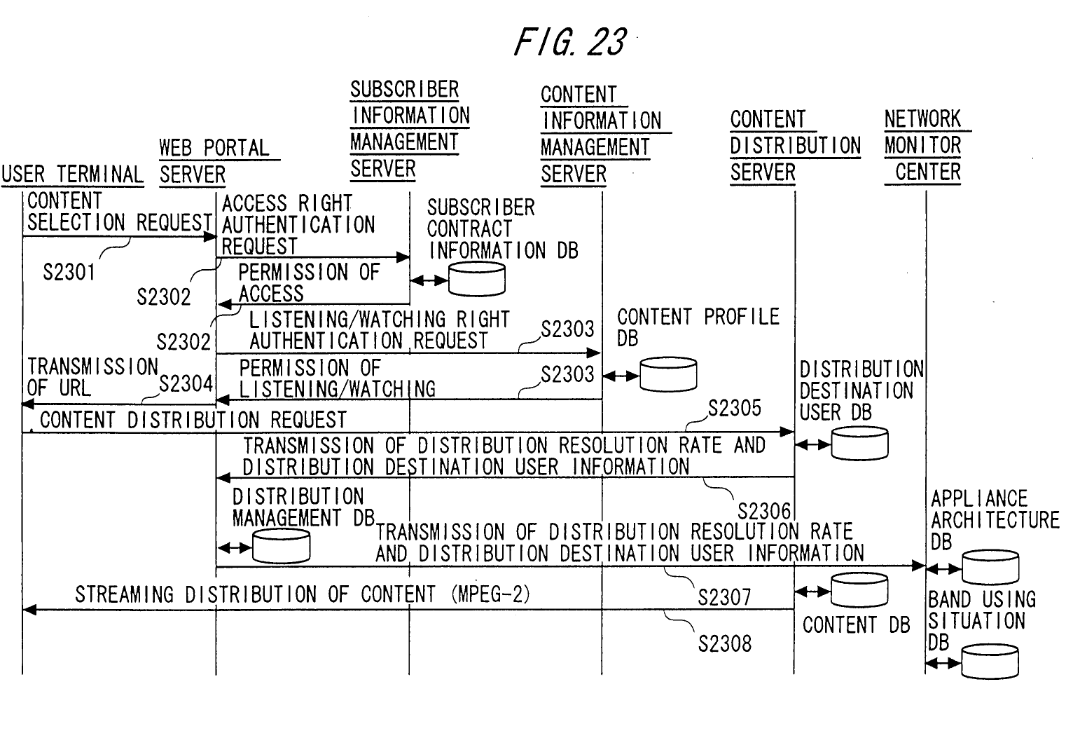

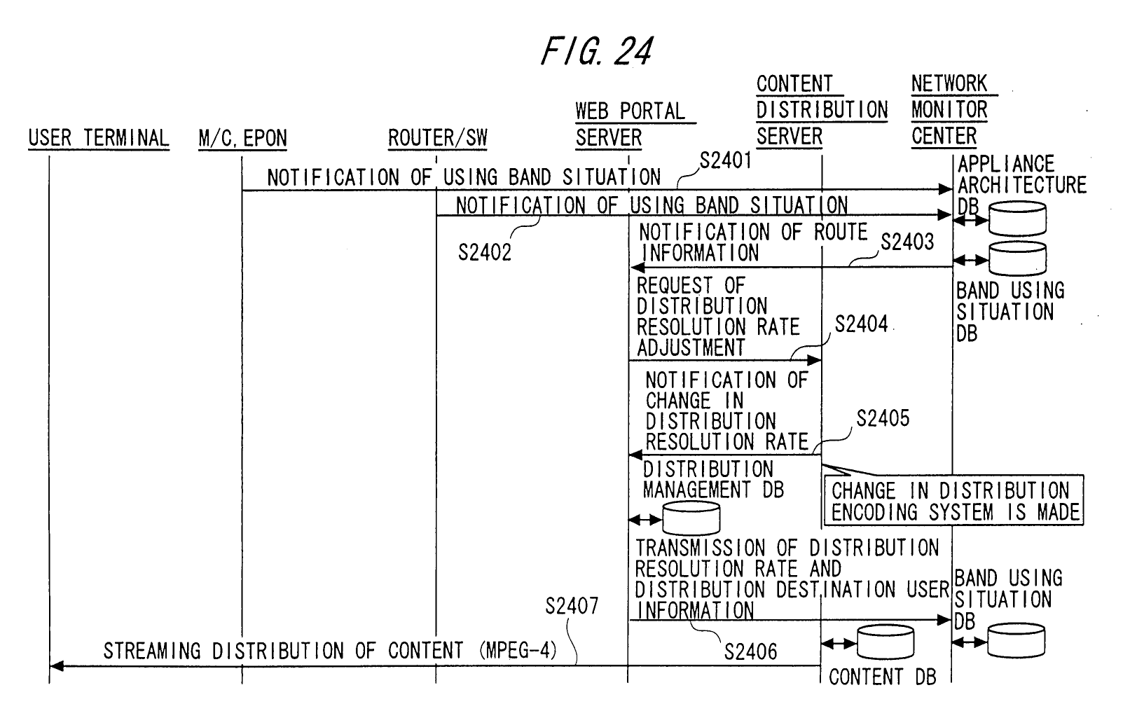

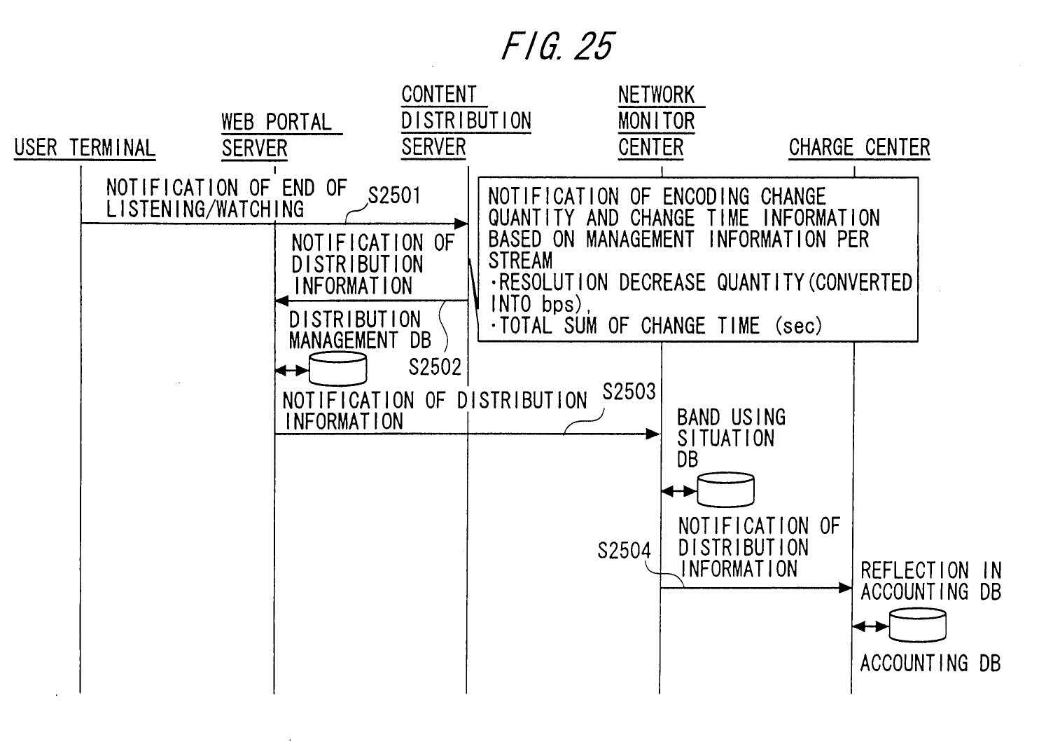

FIGS. 23 through 25 show processing sequences in the embodiment. FIG. 23 is a content selection sequence diagram in the second embodiment of the charge management method according to the invention, FIG. 24 is a content encoding change sequence diagram in the second embodiment of the charge management method according to the invention, and FIG. 25 is a distribution information management sequence diagram in the second embodiment of the charge management method according to the invention. The processing sequences between the respective devices are effected in the same way as in the first embodiment.

Namely, S2301: The user terminal selects a want-to-listen-and-watch content from on an initial screen provided by the Web portal server, and makes a listening/watching request.

S2302: The Web portal server that has received the listening/watching request gathers pieces of subscriber contract information management information of the user from the subscriber information management server, and authenticates that the user has an access right to the service. The subscriber contract information management information is stored on a subscriber contract information DB.

S2303: The Web portal server that has received the listening/watching request gathers pieces of profile management information of the content from the content information management server, and authenticates that the user has a listening/watching right to the selected content. The profile management information on this content is stored on a content profile DB.

S2304: In case the authentication is rational, the Web portal server selects a content distribution server (which is a server having a maximum allowance in its processing capacity in the case of being plural) in which the selected content is accumulated, and notifies (redirection) the user of a URL of the server.

S2305: The user terminal requests the content distribution server designated based on the URL information undergoing the redirection to distribute the selected content.

S2306: The content distribution server notifies the Web portal server of a resolution rate (e.g., an MPEG2 compression 6 Mbps distribution) of the content distribution and distribution destination user information. The self-sever also manages the information. This piece of distribution destination user information is stored on a distribution destination user DB.

S2307: The Web portal server manages the information by a distribution management DB, and notifies the network monitor center of it.

An appliance architecture of the network appliances (which is a network topology) and a band using situation are managed in centralization by the network monitor center, using an appliance architecture DB and a band using situation DB. The network monitor center receiving the notification of the information dynamically reflects it in the management data of the band using situation.

S2308: The content distribution server performs, as the notified information shows, the streaming distribution of the content (MPEG-2) to the user terminal of the user. Herein, in case the distribution band having the resolution rate (e.g., the MPEG2 compression 6 Mbps distribution) designated by the content distribution server is not left in the network, distribution NG is sent back as a response to S2306 and S2307. In this case, the content distribution server gives, as a response to S2305, a reply of being unable to distribute the content designated by the user as requested.

Further, as shown in FIG. 24, S2401: The M/C, EPON notifies at any time the network monitor center of a change in the using band situation of M/C (Media converter) or EPON (Ether Passive Optical Network).

Herein, the M/C, EPON gives the notification whenever there changes the usable band (an influence on an in-use band, and a remaining band quantity) due to a traffic occurred other than the content distribution, a fault in a part of ports, and so on.

S2402: The router/SW notifies at any time the network monitor center of a change in the using band situation of the router or the switch (SW).

Herein, the router /SW gives the notification whenever there changes the usable band (an influence on an in-use band, and a remaining band quantity) due to a traffic occurred other than the content distribution, a fault in a part of ports, and so on.

S2403: The network monitor center receiving the notifications in S2401 and S2402 notifies the Web portal server of information on a route where a situation affecting the distribution occurs on the route where the streaming distribution is conducted at that point of time, among pieces of information stored on the appliance architecture DB and on the band using situation DB.

S2404: The Web portal server receiving the notification in S2403 selects streaming information distributed on the route, and indicates the content distribution server to make an adjustment (reduction) request of the resolution rate (traffic quantity) of each streaming.

This adjustment (reduction) request can involve using, for instance, the following two methods.

(1) The resolution rates (traffic quantities) of all the streaming that passes through the route are adjusted (reduced) uniformly.

(2) There is adjusted (reduced) of the resolution rate (traffic quantity) of only the streaming for the user (who does not establish a contract of a rate assurance) with the resolution rate adjustment permitted by referring to the subscription contract condition of the distribution destination user per streaming that passes through the route.

S2405: The content distribution server, if capable of adjusting (reducing) the resolution rate (traffic quantity) according to the condition in S2504, notifies the Web portal server of this purport and changes the distribution encoding system of the streaming. If incapable of changing the distribution encoding system, it notifies of this purport.

S2406: The Web portal server manages by itself the notified information in S2405 by use of the distribution management DB, and notifies the network monitor center of it. The notified information is dynamically reflected in the monitor information of the network monitor center by use of the band using situation DB.

S2407: The content distribution server continues, according to the changed encoding system (MPEG-4), the streaming distribution.

Further, as shown in FIG. 25, S2501: The content distribution server, an end notification of the listening/watching of the content being given from the user terminal, terminates the streaming distribution. Alternatively, in case an auto reverse is not designated upon terminating the distribution of all the video contents in the process of being listened and watched by the user, the streaming distribution of the content is also automatically finished.

S2502: The content distribution server, after the end of the streaming distribution, notifies the Web portal server of the information on the streaming distribution. The notified information contains an encoding change quantity and change time information on the basis of the management information per streaming.

For example, what is converted into bps is used as a resolution decrease quantity, and what is converted into sec is used as a total sum of the change time.

S2503: The Web portal server reflects the end of the streaming distribution in its own management information by use of the distribution management DB, and notifies the network monitor center of the information obtained in S2502.

S2504: The network monitor center reflects the end of the streaming distribution in its own management information by use of the band using situation DB, and notifies the charge center of the information obtained in S2503.

The charge center receiving the notification, in terms of calculating a charge on the user, calculates a degree of discount corresponding to the change (reduction) quantity of the resolution rate and a time on the basis of the information obtained in S2503, and accumulates and manages it as a piece of charge collection information. This accumulation and the management are managed by the information stored on the accounting DB provided in the charge center.

A difference between the embodiment and the first embodiment is that two types of encoders for MPEG-2 and MPEG-4 are prepared on the user terminal side. Normally, the encoding is performed by it for MPEG-2, and, with a start of receiving the streaming on MPEG-4, there is a switchover to it for MPEG-4.

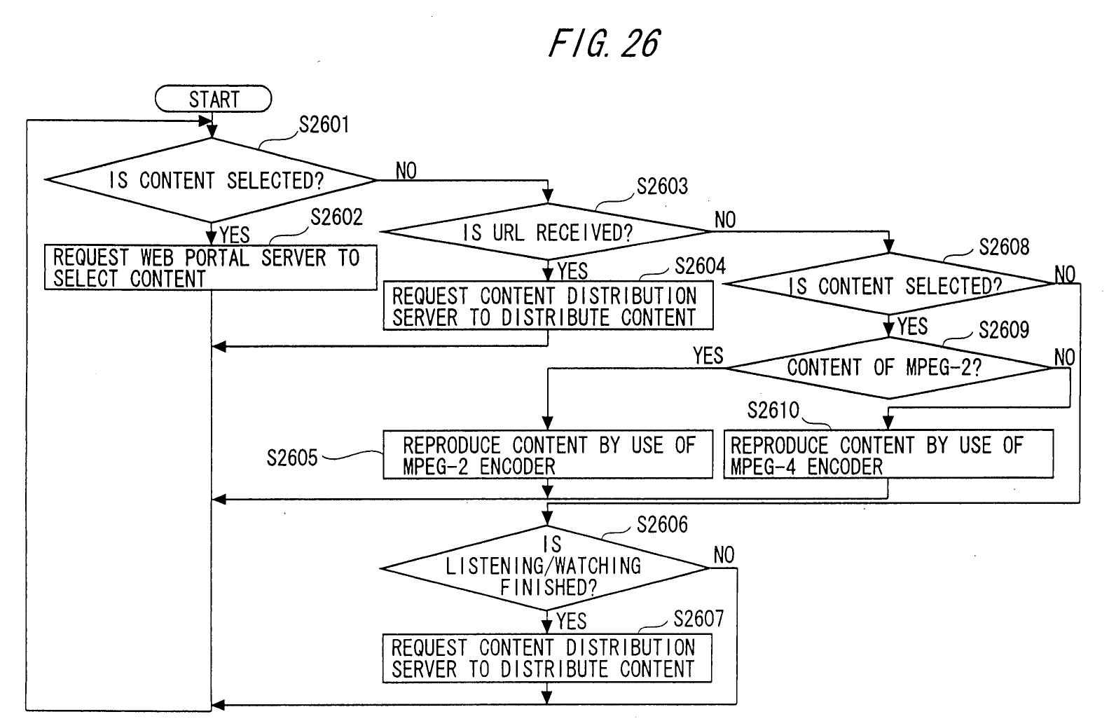

Herein, an operation in the embodiment will be explained referring to FIG. 26. FIG. 26 is a flowchart of the processing on the side of the user terminal in the second embodiment of the charge management method according to the invention. Further, content data of MPEG-2 and MPEG-4 are prepared, or a device for an MPEG-4 conversion from the MPEG-2 content data is prepared in the content distribution server.

To start with, the user terminal confirms whether the content is selected by the user or not (S2601). If the content is selected (YES), the Web portal server is requested to select the content in S2602, and, thereafter, there moves to S2601.

While on the other hand, if the content is not selected (NO), there moves to S2603, wherein it is confirmed whether the URL is received or not.

If the URL is received (YES), the content distribution server is requested to distribute the content in S2604, and, thereafter, there moves to S2601.

While on the other hand, if the URL is not received (NO), there moves to S2605, wherein it is confirmed whether the content is received or not.

If the content is received (YES), there moves to S2606, wherein it is confirmed whether it is the MPEG-2 content or not.

If it is the MPEG-2 content (YES), there moves to S2605, wherein the content is reproduced by employing the MPEG-2 encoder, and, thereafter, there moves to S2601.

In the confirmation in S2609, if it is not the MPEG-2 content (NO), there moves to S2610 in which the content is reproduced by employing the MPEG-4 encoder, and, thereafter, there moves to S2601.

While on the other hand, in the confirmation in S2608, if the content is not received (NO), there moves to S2606, wherein it is confirmed whether the listening/watching is ended or not.

If the listening/watching is ended (YES), there moves to S2607 in which the content distribution server is requested to distribute the content, and, thereafter, there moves to S2601.

While on the other hand, in the confirmation in S2606, if the listening/watching is not ended (NO), there moves to S2601.

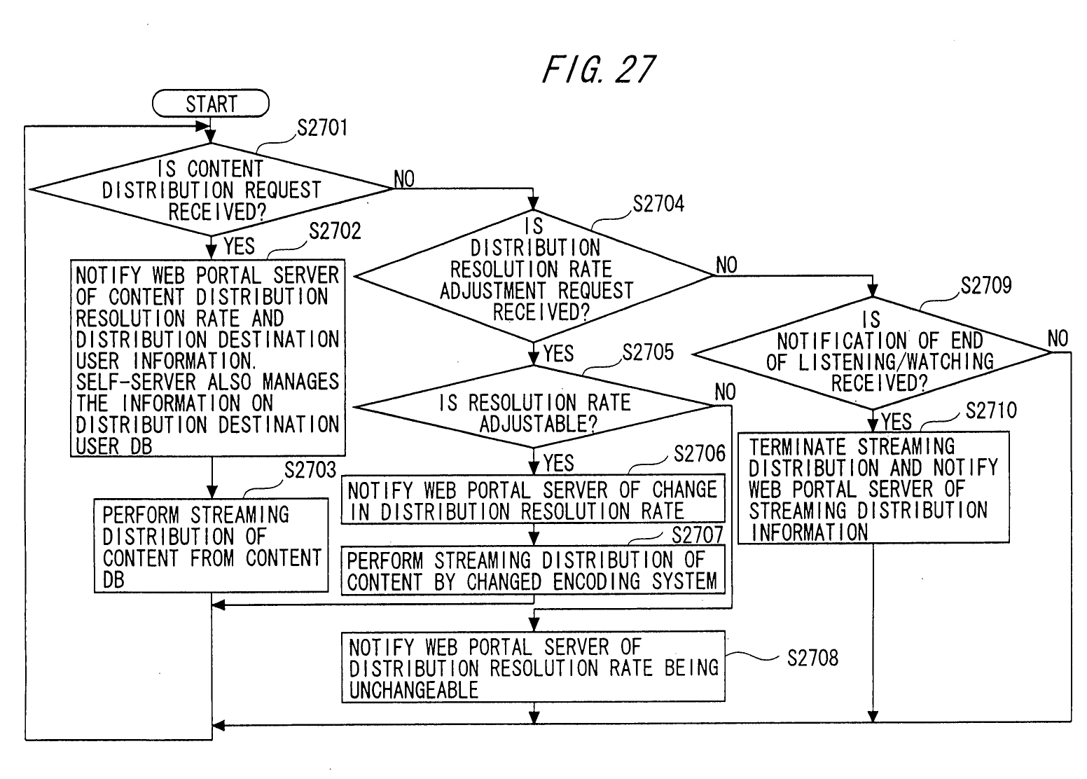

Next, the processing on the side of the content distribution server in the second embodiment of the charge management method according to the invention, will be explained. FIG. 27 is a flowchart of the processing on the side of the content distribution server in the second embodiment of the charge management method according to the invention.

To begin with, the content distribution server confirms whether a content distribution request is received or not (S2701).

The content distribution server, if the content distribution request is received (YES), moves to S2702, and notifies the Web portal server of a content distribution resolution rate and distribution destination user information. The self-server also manages the information on the distribution destination user DB.

Thereafter, the content distribution server, in S2703, does the streaming distribution of the content from the content DB, and thereafter moves to S2701.

While on the other hand, in the confirmation in S2701, in case the content distribution request is not received (NO), there moves to S2704.

In S2704, it is confirmed whether a distribution resolution rate adjustment request is received or not.

If the distribution resolution rate adjustment request is received (YES), in S2705, it is confirmed whether the resolution rate adjustment is possible or not.

If the resolution rate adjustment is possible (YES), there moves to S2706, and the Web portal server is notified of a change in the distribution resolution rate.

Then, there moves to S2707 in which the streaming distribution of the content is performed by the changed encoding system, and, thereafter, there moves to S2701.

While on the other hand, in the confirmation in S2705, if the resolution rate adjustment is not possible (NO), there moves to S2708 in which the Web portal server is notified of being impossible of changing the distribution resolution rate, and, thereafter, there moves to S2701.

While on the other hand, in the confirmation in S2704, if the distribution resolution rate adjustment request is not received (NO), there moves to S2709, wherein it is confirmed whether or not a listening/watching end notification is received or not.

If the listening/watching end notification is received in the confirmation in S2709 (YES), there moves to S2701 in which the streaming distribution is finished and a notification of the streaming distribution information is given to the Web portal server, and, thereafter, there moves to S2701.

While on the other hand, if the listening/watching end notification is not received in the confirmation in S2709 (NO), there moves to S2701.

Thus, according to the embodiment, the resolution rate is changed by changing the encoding system, the content distribution can continue without any interruption of the images, and the charge collection is also conducted, thereby making it possible to obtain the same effects as in the first embodiment of the charge management method according to the invention.

As described above, according to each of the embodiments of the invention, the charged service for distributing the content is developed, it can be applied to commercial content distribution network services wherein the listening/watching right to the designated content is given to the contract subscriber; and in these services, the user can continue to have the service without causing, though the deterioration in the resolution is recognized in the picture that is in the process of being listened to and watched, such a disturbance as to hinder the listening/watching, and, in case the resolution of the distribution content deteriorates, it is feasible to perform the content charge discount service.

What is claimed is:

1. A charge management method applied to a charge management system connected to a network connected to at least one or more user terminals, and including monitoring unit, distributing unit and accounting unit, comprising:
monitoring appliances configuring the network;
distributing a content to the user terminal; and
calculating a accounting information for the user terminal on the basis of a content distribution situation; and
wherein the distributing includes dynamically changing a resolution rate of the content on the basis of a monitored result in the monitoring, and
the calculating includes calculating the accounting information on the basis of the changed resolution rate of the content.

2. A charge management method according to claim 1, wherein the charge management system includes permitting unit connected to the network, further comprising:
determining whether a distribution of the content to the user terminal is permitted or not,
wherein the monitoring includes monitoring a content distribution condition affecting the content distribution, such as a change in a using band of the network, a fault situation of a port managed for every appliance, etc., and transmitting, in case the content distribution condition changes, change information thereof to the permitting unit; and
indicating the distributing unit to change the resolution rate on the basis of the change information.

3. A charge management method according to claim 2, wherein the indicating includes selecting the content distributed on a route shown by the change information and indicating the distributing unit to adjust a resolution rate of the selected content.

4. A charge management method according to claim 2, wherein the distributing includes changing the resolution rate through a dynamic resolution conversion (DRC: Dynamic Resolution Conversion) based on an adjustment request received from the permitting unit for ensuring a continuity of a service by adjusting a traffic quantity of the content distribution, preventing a disturbance of picture and keeping a condition worth listening to and watching, and
further comprising first transmitting to the permitting unit, resolution rate information of the content with its resolution rate changed and distribution destination user identifying information.

5. A charge management method according to claim 2, further comprising second transmitting, when the distribution of the content is ended, the resolution rate change information and the distribution destination user identifying information to the permitting unit.

6. A charge management method according to claim 2, further comprising third transmitting, when receiving the resolution rate change information through the dynamic resolution conversion which has been transmitted from the distributing unit, the resolution rate information to the monitoring unit.

7. A charge management method according to claim 2, further comprising fourth transmitting, triggered by the end of the content distribution, to the monitoring unit the resolution rate information and the distribution destination user identifying information that have been received from the distributing unit.

8. A charge management method according to claim 2, wherein the distributing includes receiving an adjustment request from the permitting unit and changing the encoding system through the dynamic encoding conversion from the information thereof, for ensuring the continuity of the service by adjusting a traffic quantity of the content distribution, preventing the disturbance of picture, and keeping the condition worth listening to and watching.

9. A charge management method according to claim 1, wherein the calculating includes accumulating a degree of discount based on a decrease quantity of the resolution rate and a distribution time in a decreased state, converting the degree of discount into a discount rate on a charge collection unit such as per end of month, etc., and calculating the accounting information by multiplying a standard charge by the discount rate.

10. A charge device connected to a charge management system which comprises at least one or more user terminals, monitoring unit monitoring appliances configuring a network, and distributing unit distributing a content to the user terminal, and
wherein the distributing unit dynamically changes a resolution rate of the content on the basis of a result of the monitoring by the monitoring unit, comprising:
accumulating unit accumulating a degree of discount based on a decrease quantity of the resolution rate and a distribution time in a decreased state;
converting unit converting the degree of discount into a discount rate on a charge collection unit such as per end of month, etc.; and
calculating unit calculating an accounting information by multiplying a standard charge by the discount rate.

11. A network monitor device connected to a charge management system which comprises at least one or more user terminals, distributing unit distributing a content to the user terminal, accounting unit calculating accounting information for the user terminal on the basis of a content distributing situation, and permitting unit for determining whether the distribution of the content to the user terminal is permitted or not,
wherein the distributing unit dynamically changes a resolution rate of the content, and
the accounting unit calculates the accounting information on the basis of the changed resolution rate of the content, comprising:
monitoring unit monitoring a content distribution condition affecting the content distribution, such as a change in a using band of the network, a fault situation of a port managed for every appliance, etc.; and
transmitting unit transmitting, in case the content distribution condition changes, change information thereof to the permitting unit; and
wherein the permitting unit indicates the distributing unit to change the resolution rate on the basis of the received change information.

12. A network monitor device according to claim 11, further comprising
first receiving unit receiving the resolution rate information, which is transmitted by the permitting unit when the permitting unit receives the resolution rate change information through the dynamic resolution conversion from the distributing unit.

13. A network monitor device according to claim 11, further comprising
second receiving unit receiving the resolution rate information and the distribution destination user identifying information, that the permitting unit have been received from the distributing unit, from the permitting unit, triggered by the end of the content distribution.

14. A Web portal server connected to a charge management system which comprises at least one or more user terminals, monitoring unit monitoring appliances configuring a network, distributing unit distributing a content to the user terminal, and accounting unit calculating accounting information for the user terminal on the basis of a content distributing situation, wherein the distributing unit dynamically changes a resolution rate of the content on the basis of a result of the monitoring by the monitoring unit, the accounting unit calculates the accounting information on the basis of the changed resolution rate of the content, and the monitoring unit monitors a content distribution condition affecting the content distribution, such as a change in a using band of the network, a fault situation of a port managed for every appliance, etc., and transmits, in case the content distribution condition changes, the change information thereof, and determining whether the distribution of the content to the user terminal is permitted or not, comprising:
selecting unit selecting the content distributed on a route shown by the change information; and
indicating unit indicating the distributing unit to adjust a resolution rate of the selected content.

15. A Web portal server according to claim 14,
wherein the indication of the indicating unit makes the distributing unit changed the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and
the distributing unit transmits, to the Web portal server, resolution rate information of the content with its resolution rate changed and distribution destination user identifying information.

16. A Web portal server according to claim 14, further comprising
receiving unit receiving a resolution rate change information and a distribution destination user identifying information, which is transmitted from the distributing unit when the distribution of the content is ended.

17. A Web portal server according to claim 14, further comprising first transmitting unit transmitting, when receiving a resolution rate change information through the dynamic resolution conversion which has been transmitted from the distributing unit, the resolution rate information to the monitoring unit.

18. A Web portal server according to claim 14, further comprising second transmitting unit transmitting, triggered by the end of the content distribution, the resolution rate information and the distribution destination user identifying information, that have been received from the distributing unit, to the monitoring unit.

19. A Web portal server according to claim 14, wherein the indication of the indicating unit makes the distributing unit changed the encoding system through the dynamic encoding conversion from the received information of the indication, for ensuring the continuity of the service by adjusting a traffic quantity of the content distribution, preventing the disturbance of picture and keeping the condition worth listening to and watching.

20. A charge management program applied to a Web portal server connected to a charge management system which comprises at least one or more user terminals, monitoring unit monitoring appliances configuring a network, distributing unit distributing a content to the user terminal, and accounting unit calculating accounting information for the user terminal on the basis of a content distributing situation, wherein the distributing unit dynamically changes a resolution rate of the content on the basis of a result of the monitoring by the monitoring unit, the accounting unit calculates the accounting information on the basis of the changed resolution rate of the content, and the monitoring unit monitors a content distribution condition affecting the content distribution, such as a change in a using band of the network, a fault situation of a port managed for every appliance, etc., and transmits, in case the content distribution condition changes, the change information thereof, and determining whether the distribution of the content to the user terminal is permitted or not, comprising:
making the Web portal server functioned as selecting unit selecting the content distributed on a route shown by the change information; and
making the Web portal server functioned as indicating unit indicating the distributing unit to adjust a resolution rate of the selected content.

21. A charge management program according to claim 20,
wherein the indication of the indicating unit makes the distributing unit changed the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and
the distributing unit transmits, to the Web portal server, resolution rate information of the content with its resolution rate changed and distribution destination user identifying information.

22. A charge management program according to claim 20, further comprising
making the Web portal server functioned as receiving unit receiving a resolution rate change information and a distribution destination user identifying information, which is transmitted from the distributing unit when the distribution of the content is ended.

23. A charge management program according to claim 20, further comprising
making the Web portal server functioned as first transmitting unit transmitting, when receiving a resolution rate change information through the dynamic resolution conversion which has been transmitted from the distributing unit, the resolution rate information to the monitoring unit.

24. A charge management program according to claim 20, further comprising
making the Web portal server functioned as second transmitting unit transmitting, triggered by the end of the content distribution, the resolution rate information and the distribution destination user identifying information that have been received from the distributing unit to the monitoring unit.

25. A charge management program according to claim 20,
wherein the indication of the indicating unit makes the distributing unit changed the encoding system through the dynamic encoding conversion from the received information of the indication, for ensuring the continuity of the service by adjusting a traffic quantity of the content distribution, preventing the disturbance of picture and keeping the condition worth listening to and watching.

26. A content distribution server connected to a charge management system which comprises at least one or more user terminals, monitoring unit monitoring appliances configuring a network, and accounting unit calculating accounting information for the user terminal on the basis of a content distributing situation and permitting unit for determining whether the distribution of the content to the user terminal is permitted or not, and distributing a content to the user terminal, comprising:
first changing unit changing dynamically a resolution rate of the content on the basis of a result of the monitoring by the monitoring unit, and
wherein the accounting unit calculates the accounting information on the basis of the changed resolution rate of the content, and
the monitoring unit monitors a content distribution condition affecting the content distribution, such as a change in a using band of the network, a fault situation of a port managed for every appliance, etc., and transmits, in case the content distribution condition changes, change information thereof to the permitting unit; and
first receiving unit receiving indication of change the resolution rate on the basis of the change information from the permitting unit.

27. A content distribution server according to claim 26, further comprising
second receiving unit receiving indication of adjustment a resolution rate of the selected content transmitted from the permitting unit, that the permitting unit selects the content distributed on a route shown by the change information.

28. A content distribution server according to claim 26, further comprising:
first changing unit changing, based on an adjustment request received from the permitting unit, the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching; and
first transmitting unit transmitting, to the permitting unit, resolution rate information of the content with its resolution rate changed and distribution destination user identifying information.

29. A content distribution server according to claim 26, further comprising
second transmitting unit transmitting, when the distribution of the content is ended, the resolution rate change information and the distribution destination user identifying information to the permitting unit.

30. A content distribution server according to claim 26, wherein the resolution rate change information through the dynamic resolution conversion which has been transmitted from the content distribution server makes the permitting unit transmitted, when the permitting unit received the resolution rate change information through the dynamic resolution conversion, the resolution rate information to the monitoring unit.

31. A content distribution server according to claim 26, wherein the resolution rate information and distribution destination user identifying information of the content transmitted to the permitting unit from the content distribution server is transmitted to the monitoring unit, triggered by the end of the content distribution, by the permitting unit.

32. A content distribution server according to claim 26, further comprising
second changing unit changing the encoding system through the dynamic encoding conversion from information of adjustment request received from the permitting unit, for ensuring the continuity of the service by adjusting a traffic quantity of the content distribution, preventing the disturbance of picture and keeping the condition worth listening to and watching.

33. A charge management program applied to a content distribution server connected to a charge management system which comprises at least one or more user terminals, monitoring unit monitoring appliances configuring a network, and accounting unit calculating accounting information for the user terminal on the basis of a content distributing situation and permitting unit for determining whether the distribution of the content to the user terminal is permitted or not, and distributing a content to the user terminal, comprising:
making the content distribution server functioned as first changing unit changing dynamically a resolution rate of the content on the basis of a result of the monitoring by the monitoring unit, and
wherein the accounting unit calculates the accounting information on the basis of the changed resolution rate of the content, and
the monitoring unit monitors a content distribution condition affecting the content distribution, such as a change in a using band of the network, a fault situation of a port managed for every appliance, etc., and transmits, in case the content distribution condition changes, change information thereof to the permitting unit; and
making the content distribution server functioned as first receiving unit receiving indication of change the resolution rate on the basis of the change information from the permitting unit.

34. A charge management program according to claim 33, further comprising
making the content distribution server functioned as second receiving unit receiving indication of adjustment a resolution rate of the selected content transmitted from the permitting unit, that the permitting unit selects the content distributed on a route shown by the change information.

35. A charge management program according to claim 33, further comprising:
making the content distribution server functioned as first changing unit changing, based on an adjustment request received from the permitting unit, the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching; and
making the content distribution server functioned as first transmitting unit transmitting, to the permitting unit, resolution rate information of the content with its resolution rate changed and distribution destination user identifying information.

36. A charge management program according to claim 33, further comprising
making the content distribution server functioned as second transmitting unit transmitting, when the distribution of the content is ended, the resolution rate change information and the distribution destination user identifying information to the permitting unit.

37. A charge management program according to claim 33, wherein the resolution rate change information through the dynamic resolution conversion which has been transmitted from the content distribution server makes the permitting unit transmitted, when the permitting unit received the resolution rate change information through the dynamic resolution conversion, the resolution rate information to the monitoring unit.

38. A charge management program according to claim 33, wherein the resolution rate information and distribution destination user identifying information of the content transmitted to the permitting unit from the content distribution server is transmitted to the monitoring unit, triggered by the end of the content distribution, by the permitting unit.

39. A charge management program according to claim 33, further comprising
making the content distribution server functioned as second changing unit changing the encoding system through the dynamic encoding conversion from information of adjustment request received from the permitting unit, for ensuring the continuity of the service by adjusting a traffic quantity of the content distribution, preventing the disturbance of picture, and keeping the condition worth listening to and watching.

40. A charge management system comprising:
at least one or more user terminals;
monitoring unit monitoring appliances configuring a network;
distributing unit distributing a content to the user terminal; and
accounting unit calculating accounting information for the user terminal on the basis of a content distributing situation,
wherein the distributing unit dynamically changes a resolution rate of the content on the basis of a result of the monitoring by the monitoring unit, and
the accounting unit calculates the accounting information on the basis of the changed resolution rate of the content.

41. A charge management system according to claim 40, further comprising permitting unit determining whether the distribution of the content to the user terminal is permitted or not,
wherein the monitoring unit monitors a content distribution condition affecting the content distribution, such as a change in a using band of the network, a fault situation of a port managed for every appliance, etc., and transmits, in case the content distribution condition changes, change information thereof to the permitting unit, and
the permitting unit indicates the distributing unit to change the resolution rate on the basis of the received change information.

42. A charge management system according to claim 41, wherein the permitting unit selects the content distributed on a route shown by the change information and indicates the distributing unit to adjust a resolution rate of the selected content.

43. A charge management system according to claim 41, wherein the distributing unit, based on the adjustment request received from the permitting unit, changing the resolution rate through a dynamic resolution conversion (DRC: Dynamic Resolution Conversion), for ensuring a continuity of a service by adjusting a traffic quantity of the content distribution, preventing a disturbance of picture and keeping a condition worth listening to and watching, and
transmitting to the permitting unit, resolution rate information of the content with its resolution rate changed and distribution destination user identifying information.

44. A charge management system according to claim 41, wherein the distributing unit transmits, when the distribution of the content is ended, the resolution rate change information and the distribution destination user identifying information to the permitting unit.

45. A charge management system according to claim 41, wherein the permitting unit transmits, when receiving the resolution rate change information through the dynamic resolution conversion which has been transmitted from the distributing unit, the resolution rate information to the monitoring unit.

46. A charge management system according to claim 41, wherein the permitting unit transmits, triggered by the end of the content distribution, to the monitoring unit the resolution rate information and the distribution destination user identifying information that have been received from the distributing unit.

47. A charge management system according to claim 41, wherein the distributing unit receiving an adjustment request from the permitting unit and changing the encoding system through the dynamic encoding conversion from the information thereof, for ensuring the continuity of the service by adjusting a traffic quantity of the content distribution, preventing the disturbance of picture, and keeping the condition worth listening to and watching.

48. A charge management system according to claim 40, wherein the accounting unit accumulates a degree of discount on the basis of a decrease quantity of the resolution rate and a distribution time in a decreased state, converts the degree of discount into a discount rate on a charge collection unit such as per end of month, etc., and calculates the accounting information by multiplying a standard charge by the discount rate.
